(19) United States
(12) Patent Application Publication
(10) Pub. No.: US 2013/0311617 A1
(43) Pub. Date: Nov. 21, 2013

(54) COMMUNICATION SYSTEM, COMMUNICATION METHOD, AND HEARTBEAT ACTING SERVER

(71) Applicant: Hitachi, Ltd., (US)

(72) Inventors: YUTA TAKAHASHI, Tokyo (JP); Koji Nishii, Tokyo (JP); Takashi Yokoyama, Tokyo (JP)

(73) Assignee: Hitachi, Ltd., Tokyo (JP)

(21) Appl. No.: 13/674,403

(22) Filed: Nov. 12, 2012

(30) Foreign Application Priority Data
Nov. 15, 2011 (JP) 2011-249757

(51) Int. Cl. H04L 12/26

(52) U.S. Cl. CPC H04L 43/10
USPC 709/219

(57) ABSTRACT

There is provided a unit for reducing the amount of data to be transmitted and received to reduce a network load. Heartbeat acting servers monitor heartbeat signals to be transmitted and received by respective physical servers (virtual machines) at entrances of data center sites, consolidate heartbeat presence or absence information of the plural physical servers (virtual machines) within the data centers, and transmit and receive the collected heartbeat information of the respective physical servers (virtual machines) between the sites in a lump.

### CLAIM OF PRIORITY

The present application claims priority from Japanese patent application JP 2011-249757 filed on Nov. 15, 2011, the content of which is hereby incorporated by reference into this application.

### BACKGROUND OF THE INVENTION

1. Technical Field

The present invention relates to a communication system, a communication method, and a heartbeat actiong server, and more particularly to a heartbeat communication system, a heartbeat communication method, and a heartbeat acting server for redundancy between remote data centers.

2. Background Art

Servers within a data center (DC) are redundantly configured to maintain the service and reduce a restoration time when there occurs trouble such that a server goes down or a hard disc crushes. Also, in order that the servers redundantly configured monitor the life and death of each other, those servers transmit a signal notifying a redundant partner of the normality of the subject server, which is called “heartbeat (HB) signal”, to each other at regular time intervals. If a trouble occurs in a real system (actual system) server, the heartbeat signal is interrupted, and a standby system (backup) server recognizes a failure of the real system server to switch one system to another. In recent years, a virtualization technology is advanced to make effective use of a hardware resource in the data center, and virtual machines within a physical server are also redundantly configured. For example, JP-A-2008-165637 discloses a technique in which a heartbeat communication is conducted between the respective virtual machines.

### SUMMARY OF THE INVENTION

On the other hand, in order to address a large-scaled disaster such that the data center per se is destroyed, it is conceivable that the respective distant virtual machines transmit and receive the heartbeat signals as described above, assuming the redundancy of the server located in the distant data center. Under the above circumstances, it is assumed that the heartbeat signals come and go through a network (NW) connecting those data center sites to compress a network traffic between the sites.

The present invention has been made from the following viewpoints, and aims at reducing the amount of data to be transmitted and received to reduce a load of a network between sites.

In the present invention, an HB-proxy server monitors heartbeat signals transmitted and received by respective servers in an entrance of a data center site, consolidates heartbeat presence or absence information on the plurality of servers within the data center, and transmits the collected heartbeat presence or absence information to a remote HB-proxy server of a redundant site in a lump. The remote HB-proxy server of the redundant site transmits the heartbeat signals to respective redundant partner servers on the basis of the received heartbeat information, to thereby realize the transmission and reception of the heartbeats between the respective servers redundantly configured.

According to the first solving means of the present invention, there is provided a communication system and a communication method in the communication system in which servers in a plurality of sites transmit and receive heartbeat (HB) packets with respect to each other in an HB transmission cycle through a network (NW), wherein

each of the sites includes:

a plurality of servers corresponding to a plurality of servers in another site;

a local-site table that stores a counter, a default of the counter, and HB presence or absence information, at a local-site side server address;

a remote site table that stores a counter, a default of the counter, and HB presence or absence information, at a remote site side server address corresponding to the local-site side server address; and

an HB-proxy server that receives an HB packet from each of the servers, and manages the local-site table and the remote site table,

after starting to act for the HB transmission and reception,

when an HB packet is transmitted from a first server of a first site, a default is loaded into the counter at an address of the first server in a first local-site table of a first HB-proxy server of the first site, and a presence of HB is set to the HB presence or absence information,

on the other hand, when the first server fails, the HB packet is not transmitted to the first HB-proxy server, the default is not loaded into the counter at the address of the first server of the first local-site table, the first HB-proxy server continues to count the counter, and the HB presence or absence information is set to no presence of HB when the counter expires,

the first HB-proxy server refers to the first local-site table at given time intervals, generates a multiplexed HB packet including in a lump the updated HB presence or absence information of the respective servers of the first site, and transmits the multiplexed HB packet to a second HB-proxy server of a second site,

the second HB-proxy server updates the respective HB presence or absence information of a second remote site table of the second HB-proxy server according to the received multiplexed HB packet,

the second HB-proxy server counts the counter, refers to the second remote site table, and, when a counter of a certain remote site side server address is expired, transmits the HB packet to a second server of the second site at the certain remote site side server address if the HB presence or absence information indicates presence of HB and

on the other hand, the second server determines that the corresponding first server fails on the basis of a fact that the HB packet is not transmitted to the second server if the HB presence or absence information indicates no presence of HB.

According to the second solving means of the present invention, there is provided a communication system and a communication method in the communication system in which servers in a plurality of sites transmit and receive heartbeat (HB) packets with respect to each other in an HB transmission cycle through a network (NW), wherein

each of the sites includes:

a plurality of servers corresponding to a plurality of servers in another site;

a local-site table that stores a counter, a default of the counter, and HB presence or absence information, at a local-site side server address;

a remote site table that stores a counter, a default of the counter, and HB presence or absence information, at a remote site side server address corresponding to the local-site side server address; and

an HB-proxy server that receives an HB request packet and an HB reply packet from each of the servers, and manages the local-site table and the remote site table, wherein

after starting to act for the HB transmission and reception,

a second HB-proxy server of a second site refers to a second local-site table of the second HB-proxy server at predetermined regular time intervals, generates a multiplexed HB packet including in a lump the HB presence or absence information of the respective servers of the second site, and transmits the multiplexed HB packet to the first HB-proxy server of the first site,

the second HB-proxy server counts the counter, loads the default when the counter at a certain remote site side server address, of a second remote site table of the second HB-proxy server expires, and transmits an HB request packet to a second server corresponding to the first server of the remote site side server address if the HB presence or absence information indicates presence of HB, and the second server transmits the HB reply packet when receiving the HB request packet if the second server is normal,

the second HB-proxy server sets the HB presence or absence information to presence of HB at the address of the second server every time the HB reply packet is received from the second server in the second local-site table, and loads the default into the counter,

on the other hand, when the second server fails, because the HB reply packet is not returned, the default is not loaded into the counter at the address of the second server of the second local-site table, and sets the HB presence or absence information to no presence of HB if the counter expires after a given time,

the first HB-proxy server updates the respective HB presence or absence information of the first remote site table of the first HB-proxy server according to the received multiplexed HB packet,

upon receiving the HB request packet from the first server, the first HB-proxy server refers to the updated first remote site table, and returns the HB reply packet to the first server if the HB presence or absence information at the address of the second server corresponding to the first server indicates presence of HB, and

on the other hand, if the HB presence or absence information at the address of the second server corresponding to the first server indicates no presence of HB, the first server determines that the corresponding second server fails, on the basis of a fact that the HB reply packet is not transmitted to the first server.

According to the third solving means of the present invention, there is provided a heartbeat action server in a communication system in which servers in a plurality of sites transmit and receive heartbeat (HB) packets with respect to each other in an HB transmission cycle through a network (NW), and each of the sites includes a plurality of servers corresponding to a plurality of servers in another site,

each of the HB-proxy servers of each of the sites comprising:

a local-site table that stores a counter, a default of the counter, and HB presence or absence information, at a local-site side server address;

a remote site table that stores a counter, a default of the counter, and HB presence or absence information, at a remote site side server address corresponding to the local-site side server address;

wherein each of the HB-proxy servers receives an HB packet from each of the servers, and manages the local-site table and the remote site table,

after starting to act for the HB transmission and reception,

when an HB packet is transmitted from a first server of a first site, a default is loaded into the counter at an address of the first server in a first local-site table of a first HB-proxy server of the first site, and a presence of HB is set to the HB presence or absence information,

on the other hand, when the first server fails, the HB packet is not transmitted to the first HB-proxy server, the default is not loaded into the counter at the address of the first server of the first local-site table, the first HB-proxy server continues to count the counter, and the HB presence or absence information is set to no presence of HB when the counter expires,

the first HB-proxy server refers to the first local-site table at given time intervals, generates a multiplexed HB packet including in a lump the updated HB presence or absence information of the respective servers of the first site, and transmits the multiplexed HB packet to a second HB-proxy server of a second site,

the second HB-proxy server updates the respective HB presence or absence information of a second remote site table of the second HB-proxy server according to the received multiplexed HB packet,

the second HB-proxy server counts the counter, refers to the second remote site table, and when a counter of a certain remote site side server address is expired, transmits the HB packet to a second server of the second site at the certain remote site side server address if the HB presence or absence information indicates presence of HB and

on the other hand, the second server determines that the corresponding first server fails on the basis of a fact that the HB packet is not transmitted to the second server if the HB presence or absence information indicates no presence of HB.

According to the fourth solving means of the present invention, there is provided a heartbeat actiong server in a communication system in which servers in a plurality of sites transmit and receive heartbeat (HB) packets with respect to each other in an HB transmission cycle through a network (NW), and each of the sites includes a plurality of servers corresponding to a plurality of servers in another site,

each of the HB-proxy servers of each of the sites comprising:

a local-site table that stores a counter, a default of the counter, and HB presence or absence information, at a local-site side server address;

a remote site table that stores a counter, a default of the counter, and HB presence or absence information, at a remote site side server address corresponding to the local-site side server address;

wherein each of the HB-proxy servers receives an HB request packet and an HB reply packet from each of the servers, and manages the local-site table and the remote site table, wherein

after starting to act for the HB transmission and reception,

a second HB-proxy server of a second site refers to a second local-site table of the second HB-proxy server at predetermined regular time intervals, generates a multiplexed HB packet including in a lump the HB presence or absence information of the respective servers of the second site, and transmits the multiplexed HB packet to the first HB-proxy server of the first site,

the second HB-proxy server counts the counter, loads the default when the counter at a certain remote site side server address, of a second remote site table of the second HB-proxy server expires, and transmits an HB request packet to a second server corresponding to the first server of the remote site side server address if the HB presence or absence information indicates presence of HB, and the second server transmits the HB reply packet when receiving the HB request packet if the second server is normal,

the second HB-proxy server sets the HB presence or absence information to presence of HB at the address of the second server every time the HB reply packet is received from the second server in the second local-site table, and loads the default into the counter,

on the other hand, when the second server fails, because the HB reply packet is not returned, the default is not loaded into the counter at the address of the second server of the second local-site table, and sets the HB presence or absence information to no presence of HB if the counter expires after a given time,

the first HB-proxy server updates the respective HB presence or absence information of the first remote site table of the first HB-proxy server according to the received multiplexed HB packet,

upon receiving the HB request packet from the first server, the first HB-proxy server refers to the updated first remote site table, and returns the HB reply packet to the first server if the HB presence or absence information at the address of the second server corresponding to the first server indicates presence of HB, and

on the other hand, if the HB presence or absence information at the address of the second server corresponding to the first server indicates no presence of HB, the first server determines that the corresponding second server fails, on the basis of a fact that the HB reply packet is not transmitted to the first server.

According to the present invention, respective data related to a source address, a destination address, the other protocol dependent header, and the heart beat information, which is included in the heart beat signal to be transmitted to the redundant partner server by each of the servers within the data center site, can be consolidated by the HB-proxy server in the data center site entrance. Also, according to the present invention, because the HB-proxy server transmits only the heartbeat information on the respective servers to the counter HB-proxy server of the redundant site in a lump, the amount of data flowing between the sites can be reduced to enable a reduction in the load of the network, as compared with a case in which the respective servers transmit and receive the heartbeat signals, individually.

### BRIEF DESCRIPTION OF THE DRAWINGS

FIG. 1 is a diagram illustrating a system configuration of a data center (DC) according to an embodiment;

FIG. 2 is a diagram illustrating a configuration of an HB-proxy server according to a first embodiment;

FIG. 3A illustrates an example of a local data center table provided in the HB-proxy server;

FIG. 3B illustrates an example of a counter data center table provided in the HB-proxy server;

FIG. 3C illustrates an example of a normal HB packet transmitted and received by each server within the data center;

FIG. 3D illustrates an example of a Multiplexed HB packet transmitted and received by the HB-proxy server;

FIG. 4 is a flowchart of processing in an HB receiving unit on the DC side;

FIG. 5 is a flowchart of processing in an HB transmitting unit on the NW side;

FIG. 6 is a flowchart of processing in a table management unit for a local DC;

FIG. 7A is a flowchart of processing in an HB receiving unit on the NW side;

FIG. 7B is a flowchart of processing in an HB transmitting unit on the DC side;

FIG. 8A is a flowchart of processing in a table management unit for a remote DC;

FIG. 8B is a flowchart of the processing in the table management unit for the remote DC;

FIG. 8C is a flowchart of processing in a counter for the remote DC;

FIG. 9 is a sequence diagram of the first embodiment;

FIG. 10 is a diagram illustrating the transition of a table for the local DC within an HB-proxy server A;

FIG. 11 is a diagram illustrating the transition of a table for the remote DC within an HB-proxy server B;

FIG. 12A is a diagram illustrating an HB presence or absence bit, and the transition of a subtraction counter within the table for the local DC;

FIG. 12B is a diagram illustrating an HB presence or absence bit, and the transition of a subtraction counter within the table for the remote DC;

FIG. 13 is a diagram illustrating a configuration of the HB-proxy server according to a second embodiment;

FIG. 14 is a flowchart of the processing in the HB receiving unit on the DC side;

FIG. 15 is a flowchart of the processing in the HB receiving unit on the NW side;

FIG. 16A is a flowchart of the processing in the table management unit for the remote DC;

FIG. 16B is a flowchart of the processing in the table management unit for the remote DC;

FIG. 16C is a flowchart of the processing in the table management unit for the remote DC;

FIG. 17 is a sequence diagram of the second embodiment;

FIG. 18 is a diagram illustrating the transition of the table for the local DC within the HB-proxy server B;

FIG. 19 is a diagram illustrating the transition of the table for the remote DC;

FIG. 20A is a diagram illustrating an HB presence or absence bit and the transition of a subtraction counter within the table for the local DC; and

FIG. 20B is a diagram illustrating an HB presence or absence bit and the transition of a subtraction counter within the table for the remote DC.

### DETAILED DESCRIPTION OF THE PREFERRED EMBODIMENTS

Hereinafter, an embodiment of the present invention will be described in detail with reference to the accompanying drawings.

### A. First Embodiment

### 1. System

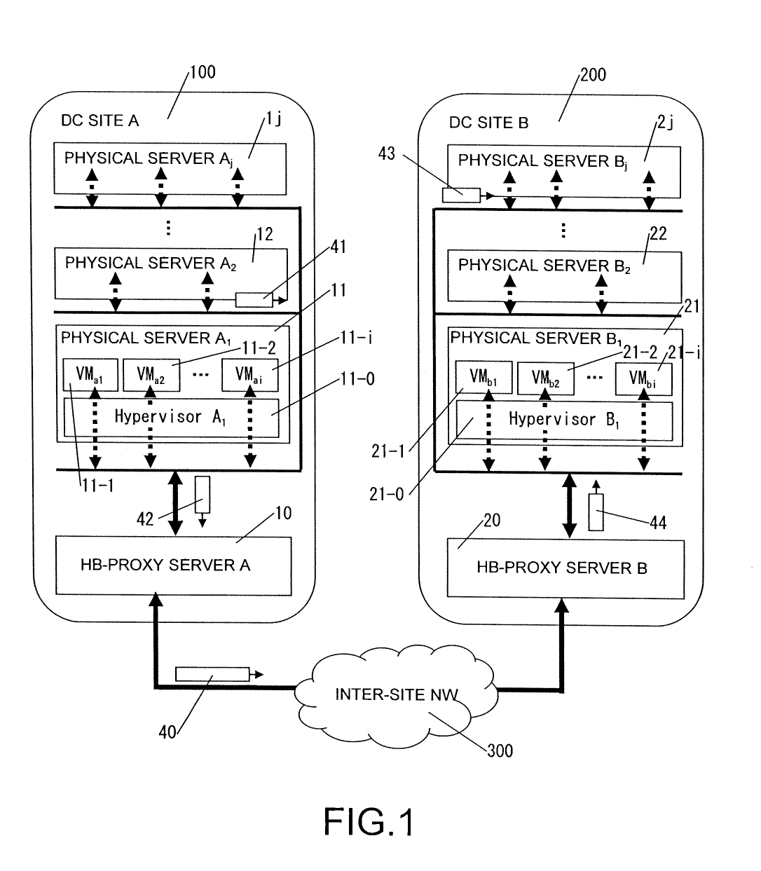

FIG. 1 illustrates a network configured by data centers (DCs) according to this embodiment. A DC site A (100) transmits and receives heartbeat (HB) signals with respect to a DC site B (200) which is a distant data center, through an inter-site network (NW) (300).

The DC site A (100) includes a physical server A₁ (11), a physical server A₂ (12), . . . , a physical server Aⱼ (1ⱼ), and an HB-proxy server A (10) that is the feature of the present invention.

Also, the physical server A₁ (11) includes a hypervisor A₁(11-0) that makes a plurality of virtual machines operable, and a virtual machine VMₐ₁(11-1) that operates as a virtual server, a virtual machine VMₐ₂(11-2), . . . , a virtual machine VMₐⱼ(11-i) which operate as the virtual server, within the physical server.

Likewise, the DC site B (200) includes, as components consisting the data center, a physical server B₁ (21), a physical server B₂ (22), . . . , a physical server Bⱼ (2ⱼ), and an HB-proxy server B (20) that is the feature of the present invention.

Also, the physical server B₁ (21) includes a hypervisor B₁(21-0) that makes a plurality of virtual machines operable, and a virtual machine VM_{b1}(21-1) that operates as the virtual server, a virtual machine VM_{b2}(21-2), . . . , a virtual machine VM_{bj}(21-i) which operate as the virtual server, within the physical server.

The HB-proxy server A (10) receives HB packets (41, 42) transmitted from the respective servers such as the physical servers or the virtual machines within the DC site A (100), and manages HB transmission presence or absence information of the respective servers within the DC site A (100) together with addresses of the respective servers and addresses of redundant partner servers. Also, the HB-proxy server A (10) transmits the collected HB transmission presence or absence information of the respective servers to the HB-proxy server B (20) through the NW between the sites as a Multiplexed HB packet (40) in a lump.

The HB-proxy server B (20) transmits HB packets (43, 44) to the respective servers within the DC site B on the basis of the HB transmission presence or absence information of the respective servers within the DC site A (100) acquired from the received Multiplexed HB packet (40). Through the above procedure, the HB packets are transmitted from the servers within the DC site A (100) to the servers within the DC site B (200).

In this embodiment, a description will be given of a system in which m pairs of servers redundantly configured between different data center sites transmit the HB packets to each other at regular time intervals.

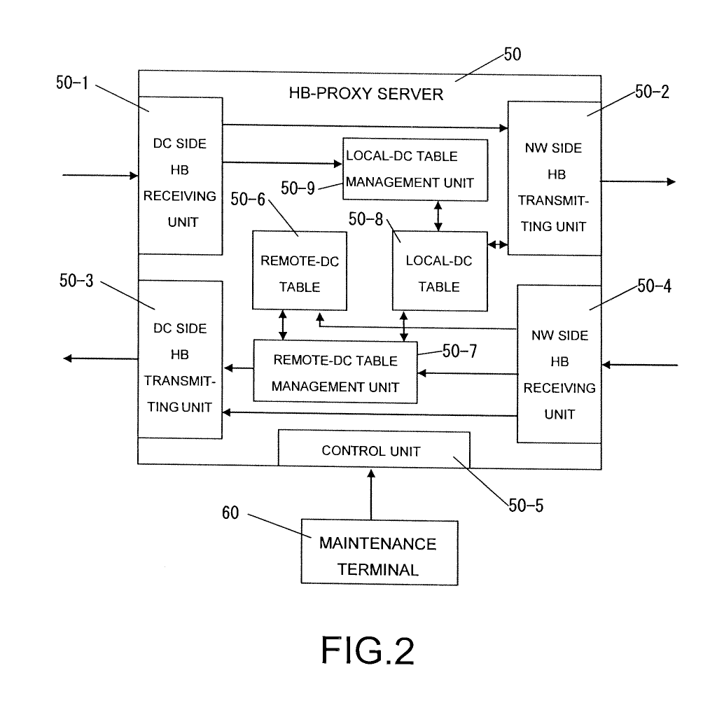

FIG. 2 illustrates the HB-proxy server according to the first embodiment.

An HB-proxy server (50) includes a DC side HB receiving unit (50-1), an NW side HB transmitting unit (50-2), a DC side HB transmitting unit (50-3), an NW side HB receiving unit (50-4), a control unit (50-5), a remote DC table (50-6), a remote DC table management unit (50-7), a local DC table (50-8), and a local DC table management unit (50-9).

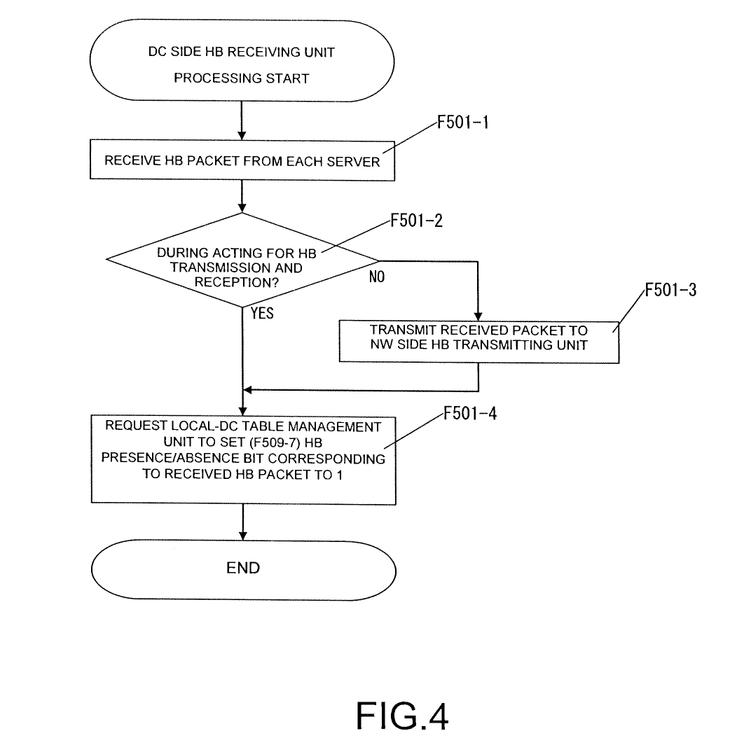

The DC side HB receiving unit (50-1) is a block that receives the HB packets transmitted from the DC site to the NW side between the sites. As illustrated in a flowchart of FIG. 4 (which will be described in detail later), upon receiving the HB packet, the DC side HB receiving unit (50-1) requests local DC table update processing to the local DC table management unit (50-9) if the DC side HB receiving unit (50-1) is acting for the HB transmission and reception. Also, in a table learning stage before acting for transmission and reception of the HB packets, the DC side HB receiving unit (50-1) also transfers the received HB packets to the NW side HB transmitting unit (50-2).

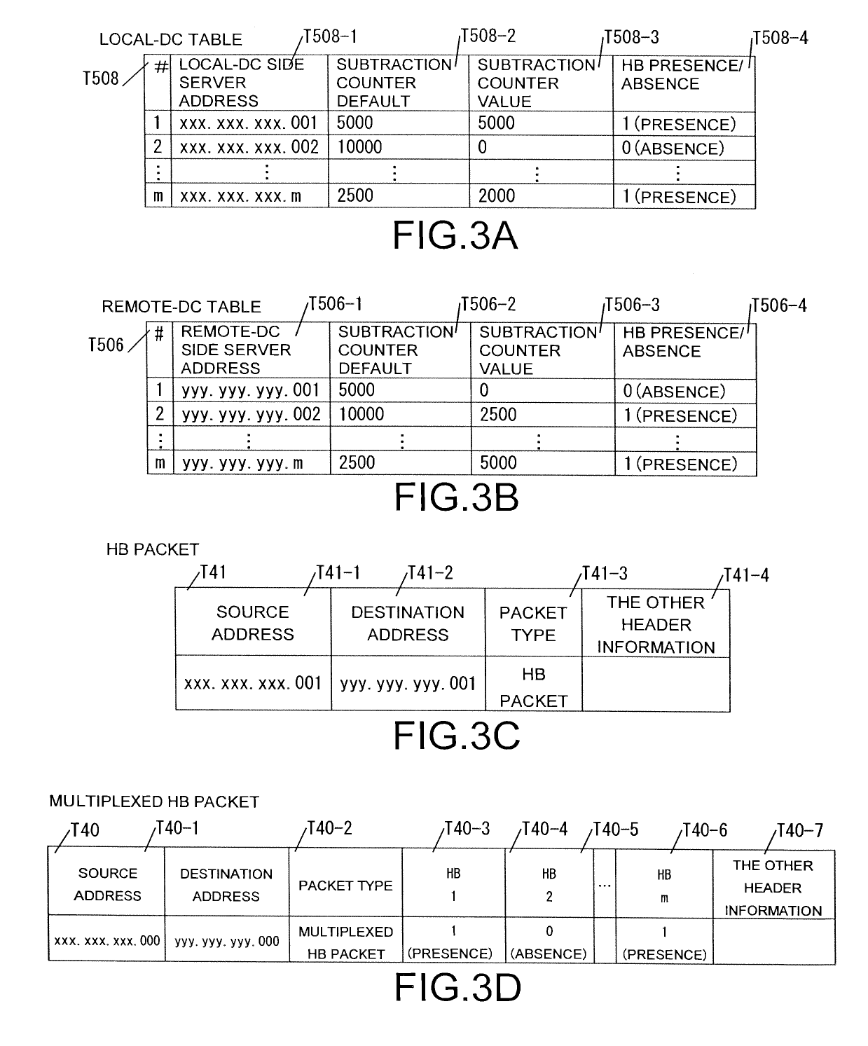

FIG. 3A is a diagram illustrating an example of the local data center table provided in the HB-proxy server.

The local DC tables (50-8, T508) are tables in which HB information of the respective servers within the local DC site is recorded, and as illustrated in FIG. 3A, stores addresses of the respective servers within the local DC site (T508-1), defaults (T508-2) of a subtraction counter, subtraction counter values (T508-3) for counting time until it is determined that there is no HB transmission, and HB reception presence or absence information (T508-4) of the HB-proxy server, correspondingly. As the server addresses of the respective tables, the addresses of the servers may be used, or the addresses (address of VM) of the server including the address of the VM may be used. In the subtraction counter values (T508-3), when the HB packet is received, the default (T508-2) is loaded, and a countdown is continued until the subsequent HB packet is received, or the count value becomes 0. When the HB-proxy server gets out of receiving the HB packet, the count value becomes 0. This leads to the determination that there is no HB packet.

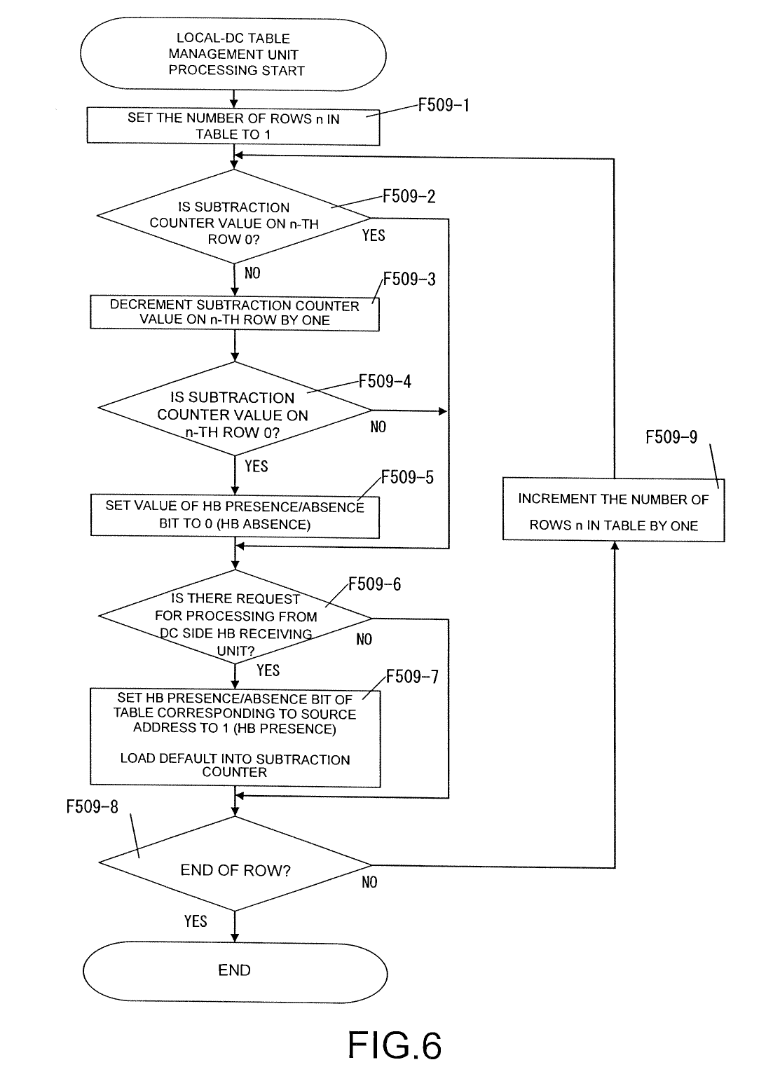

The local DC table management unit (50-9) is a block that updates the local DC table. As illustrated in FIG. 6 (which will be described in detail later), the local DC table management unit (50-9) receives a request for the local DC table update processing from the DC side HB receiving unit (50-1), searches the local DC table from a source address (T41-1) of a received HB packet (T41), and rewrites the HB reception presence or absence information on an appropriate row of the local DC table as 1 (HB presence). Also, the local DC table management unit (50-9) also updates values of the respective subtraction counters within the local DC table (50-8).

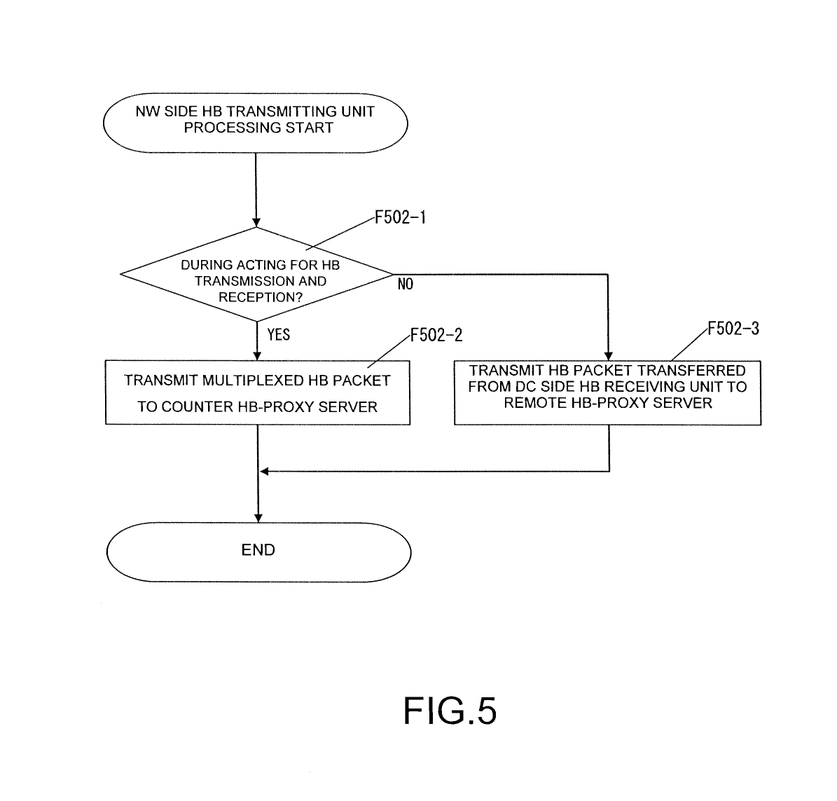

The NW side HB transmitting unit (50-2) is a block that transmits the HB packet to the NW side from the HB-proxy server, and as illustrated in a flowchart of FIG. 5 (which will be described in detail later), the NW side HB transmitting unit (50-2) transmits the HB packet transferred from the DC side HB receiving unit (50-1) to the NW side before acting for the HB packet transmission and reception. Also, the NW side HB transmitting unit (50-2) refers to the respective HB presence or absence information (T508-4) of the local DC table (50-8) while acting for the HB packet transmission and reception, generates the Multiplexed HB packet (40), and transmits the generated Multiplexed HB packet (40) to the counter HB-proxy server.

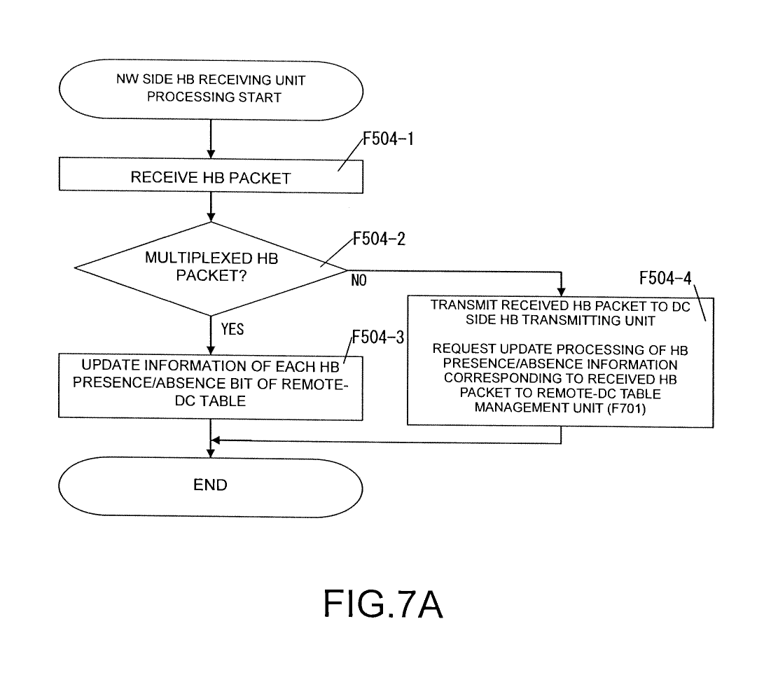

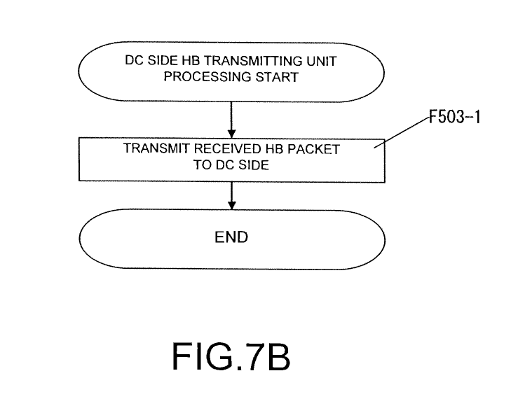

The NW side HB receiving unit (50-4) is a block that receives the packet transmitted from the NW side. As illustrated in the flowchart of FIG. 7A (which will be described in detail later), the NW side HB receiving unit (50-4) distinguishes the received HB packets between the normal HB packet and the Multiplexed HB packet, transfers the received HB packet to the DC side HB transmitting unit (50-3) if the received HB packet is the normal HB packet, and requests the remote DC table (50-6) update processing to the remote DC table management unit (50-7). If the received HB packet is the Multiplexed HB packet, the NW side HB receiving unit (50-4) directly updates the HB reception presence or absence information of the remote DC table (50-6) on the basis of the received data.

FIG. 3B is a diagram illustrating an example of the counter data center table provided in the HB-proxy server.

The remote DC tables (50-6, T506) are tables in which the HB information of the respective servers within the redundant remote DC site is recorded, and as illustrated in FIG. 3B, stores addresses of the respective servers within the remote DC site (T506-1), defaults (T506-2) of a subtraction counter, subtraction counter values (T506-3) for counting a specific time, and HB transmission presence or absence information (T506-4), correspondingly. As the server addresses of the respective tables, the addresses of the physical servers may be used, or the addresses of the VM may be used. In the subtraction counter values (T506-3), before acting for the HB transmission and reception, when the HB packet is received, the defaults (T506-2) is loaded, and a countdown is continued until the subsequent HB packet is received, or the count value becomes 0. When the HB-proxy server gets out of receiving the HB packet, the count value becomes 0. This leads to the determination that there is no HB packet, and the HB-proxy server acts as a timer since receiving the HB packet till the determination that there is no HB transmission. After acting for the HB packet transmission and reception, the subtraction counter values (T506-3) function as a timer announcing times at which the HB packets are transmitted to the respective servers within the local DC site, and the defaults (T506-2) are loaded every time the HB packets are transmitted.

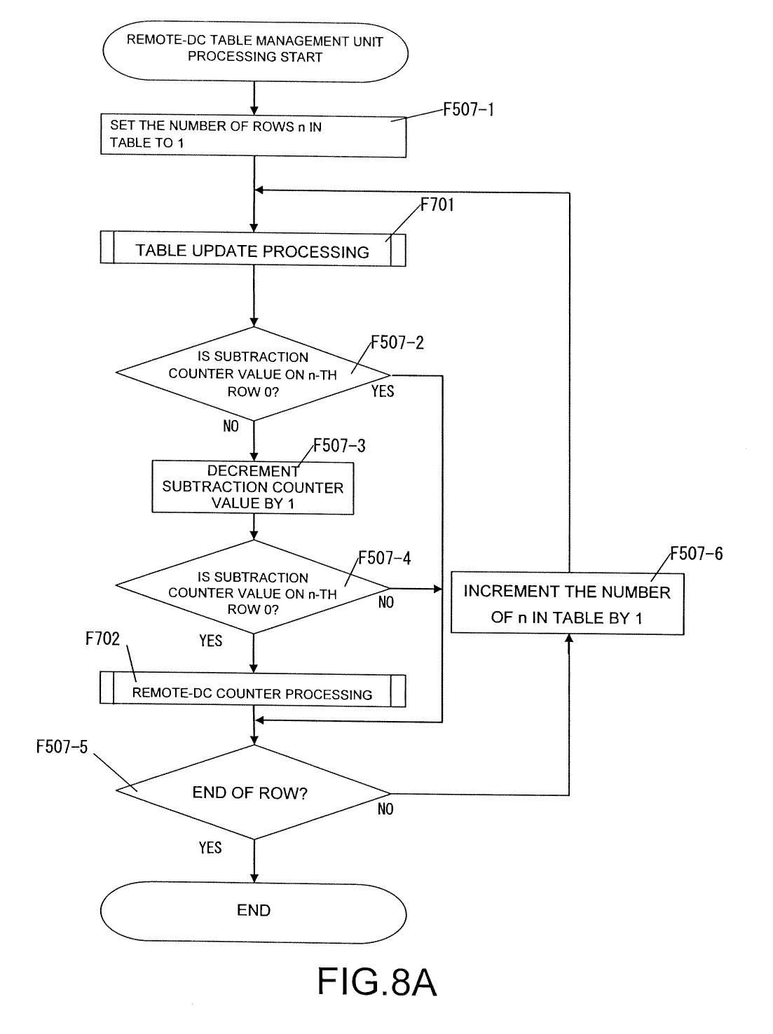

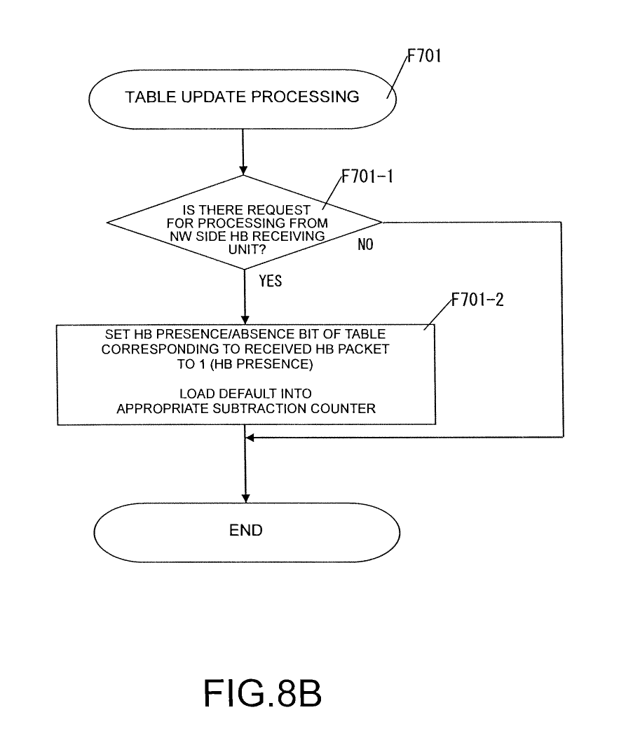

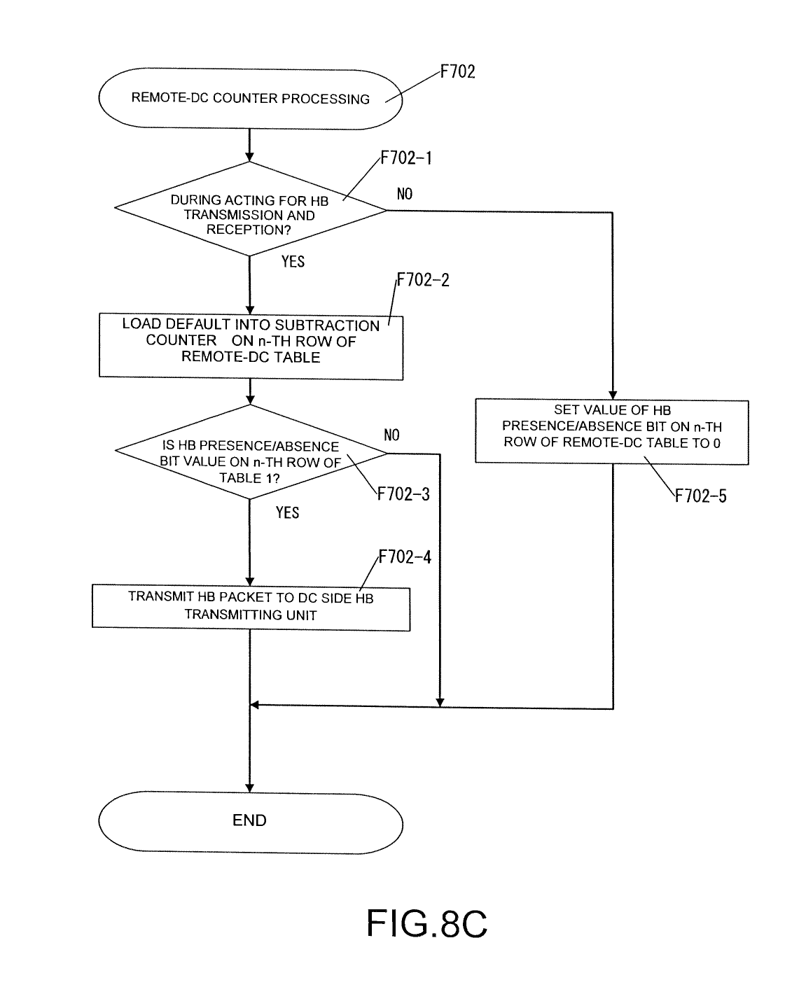

The remote DC table management unit (50-7) is a block that updates the remote DC table. As illustrated in flowcharts of FIGS. 8A, 8B, and 8C (which will be described in detail later), the remote DC table management unit (50-7) receives a request for the remote DC table update processing from the NW side HB receiving unit (50-4) before acting for the HB packet transmission and reception, searches the remote DC table from the source address (T41-1) of the received HB packet (T41), and rewrites the HB reception presence or absence information on an appropriate row of the remote DC table. While acting for the HB packet transmission and reception, the remote DC table management unit (50-7) transmits the HB packets to the DC side HB transmitting unit in a cycle of the subtraction counter. Also, the remote DC table management unit (50-7) also updates values of the respective subtraction counters within the local DC table (50-8) regardless of whether to act for the HB packet transmission and reception, or not.

The DC side HB transmitting unit (50-3) is a block that transmits the HB packet to the respective servers within the local DC. As illustrated in FIG. 7B (which will be described in detail later), the DC side HB transmitting unit (50-3) transmits the HB packets transmitted from the NW side HB receiving unit (50-4) and the remote DC table management unit (50-7) to the respective servers within the local DC.

A maintenance terminal (60) is used for initializing the local DC table (50-8) and the remote DC table (50-6) and setting the transmission interval of the Multiplexed HB packet and pairs of the redundant configuration. Also, the HB transmission and reception acting start is conducted by setting the maintenance terminal (60).

The control unit (50-5) is a block that actually sets the respective setting values input by a maintenance person through the maintenance terminal (60) for the respective units of the HB-proxy server.

### 2. Operation Flow

### (1) Assumption

Hereinafter, a description will be given of the respective function blocks with reference to FIGS. 4, 5, 6, 7A, 7B, 8A, 8B, and 8C. Processing illustrated in FIGS. 4, 5, 6, 7A, 7B, and 8A shows only one processing, but in fact the processing of the flowcharts is repetitively executed.

Before operating the HB-proxy server, the maintenance person sets information on the servers redundantly configured between the data centers for the local DC table (T508) and the remote DC table (T506) by the maintenance terminal (60). In more detail, for example, the addresses (T508-1, T506-1) of the respective servers redundantly configured within the local data center and the counter data center are registered, and the defaults (T508-2, T506-2) of the subtraction counter are set. Also, the subtraction counter values (T508-3, T506-3) are set to 0, the HB presence or absence bit (T508-4, T506-4) are set to 0 (HB absence), and the transmission cycle of the Multiplexed HB packet and the pairs redundantly configured are set. However, in this embodiment, for simplification, it is assumed that a server corresponding to an n-th row of the local DC table (T508) and a server corresponding to an n-th row of the remote DC table (T506) are paired as the redundant configuration. As the server addresses of the respective tables, the address of the physical server may be used, or the address of the VM may be used.

When the default is completed by the maintenance person, the HB-proxy server monitors the HB packets transmitted from the respective servers, and transfers the HB packets to the network side until receiving an instruction to act for the HB transmission and reception from the maintenance person, in order to learn the HB presence or absence information in the local DC table and the remote DC table.

FIG. 4 is a flowchart of the processing in the DC side HB receiving unit.

When the physical server or the virtual machine transmits the HB packet to the redundant partner server of the redundant remote DC site, the HB packet is received by the DC side HB receiving unit of the HB-proxy server (F501-1).

FIG. 3C is a diagram illustrating an example of a normal HB packet transmitted and received by the respective servers within the DC.

As illustrated in FIG. 3C, the HB packet (T41) includes the source address (T41-1), a destination address (T41-2), information (T41-3) indicating that the packet is the normal HB packet, and the other header information (T41-4) depending on a protocol.

### (2) Before Acting for HB Transmission and Reception

i) HB Packet Transmission

If the HB transmission and reception has not yet been acted (F501-2), in order that the HB-proxy server monitors the HB packet and updates the table, the DC side HB receiving unit transfers the received packet to the NW side HB transmitting unit as it is (F501-3), and requests the local DC table update processing to the local DC table management unit (F501-4).

FIG. 6 is a flowchart of the processing of the local DC table management.

The local DC table management unit receives the request from the DC side HB receiving unit (F509-6), searches the local DC table on the basis of the source address, sets the appropriate HB presence or absence bit of the local DC table to 1 (HB presence), and loads the default into the subtraction counter value (F509-7). Also, the local DC table management unit decrements the counter value in order from a first row (F509-1) of the table one by one (F509-3). Unless the subtraction counter value of a certain row is 0 (F509-2), the local DC table management unit decrements the subtraction counter value on the same row by one (F509-3). If the decremented result is 0 (F509-4), the local DC table management unit sets the HB presence or absence bit on the same row to 0 (HB absence) (F509-5). The local DC table management unit repeats the above-mentioned counter subtraction processing till a final row of the table (F509-8, F509-9).

ii) HB Packet Reception

FIG. 5 is a flowchart of the processing in the NW side HB transmitting unit.

If the HB transmission and reception has not yet been acted (F502-1), the NW side HB transmitting unit transmits the HB packet transferred from the DC side HB receiving unit to the counter HB-proxy server through the NW between the sites (F502-3).

FIG. 7A is a flowchart of the processing in the NW side HB receiving unit.

The HB packet that has arrived at the HB-proxy server through the NW between the sites is received by the NW side HB receiving unit (F504-1). The NW side HB receiving unit distinguishes whether the received HB packet is the normal HB packet or the multiplexed HB packet lumped by the HB-proxy server (F504-2). If the received HB packet is the normal HB packet, the NW side HB receiving unit transfers the received HB packet to the DC side HB transmitting unit, and requests the remote DC table update to the remote DC side table management unit (F504-4).

FIG. 7B is a flowchart of the processing in the DC side HB transmitting unit.

The DC side HB transmitting unit transmits the transmitted packets to the respective servers within the DC site as they are regardless of whether the HB-proxy server is acting for the HB transmission and reception (F503-1).

FIG. 8B is a flowchart of the processing within the remote DC table management unit.

If there is a request (F701-1) for a remote DC table update processing (F701), the remote DC table management unit (50-7) sets the HB presence or absence bit of the HB packet source present in the remote DC table to 1 (HB presence) on the basis of the source address of the received HB packet, and loads the default into the appropriate subtraction counter (F701-2).

FIG. 8A is a flowchart of the processing in the remote DC table management unit. Also, FIG. 8C is a flowchart of the processing in the remote DC counter.

Also, the remote DC table management unit decrements the counter value in order from a first row (F507-1) of the remote DC table one by one (F507-3). Unless the subtraction counter value of a certain row is 0 (F507-2), the remote DC table management unit decrements the subtraction counter value on the same row by one (F507-3). If the decremented result is 0 (F507-4), the remote DC table management unit executes the remote DC counter processing (F702), and sets the HB presence or absence bit on the same row to 0 (HB absence) (F702-5) as illustrated in FIG. 8C. The remote DC table management unit repeats the above-mentioned counter subtraction processing till a final row of the table (F507-5, F507-6).

### (3) After Acting for HB Transmission and Reception

i) HB Packet Transmission

As illustrated in FIG. 4, with setting from the maintenance terminal, when starting to act for the transmission and reception of the HB packet (F501-2), the DC side HB receiving unit (50-1) does not transfer the HB packet to the NW side HB transmitting unit (50-2), but requests the update processing of the HB presence or absence bit (T508-4) of the local DC table (T508-4) to the local DC table management unit (F501-4).

As illustrated in FIG. 6, the local DC table management unit updates the subtraction counter value (T508-3) and the HB presence or absence bit (T508-4) in the same manner as that before acting for the HB transmission and reception.

As illustrated in FIG. 5, if the HB transmission and reception are acted (F502-1), the NW side HB transmitting unit (50-2) reads the values of the respective HB presence or absence bits (T508-4) of the local DC table (T508), creates an HB presence or absence bit map, and transmits the created HB presence or absence bit map to the counter HB-proxy server as a multiplexed HB packet (T40) (F502-2).

FIG. 3D is a diagram illustrating an example of the Multiplexed HB packet transmitted or received by the HB-proxy server.

In this example, as illustrated in FIG. 3D, the multiplexed HB packet (T40) includes a source address (T40-1), a destination address (T40-2), a packet type (T40-3), HB presence or absence bit maps (T40-4, T40-5, T40-6), and the other header information (T40-7) depending on the protocol.

ii) HB Packet Reception

As illustrated in FIG. 7A, when the NW side HB receiving unit (50-1) determines that the multiplexed HB packet (T40) has been received according to whether the packet type (T40-3) is the multiplexed HB packet, or not (F504-1, F504-2), the NW side HB receiving unit (50-1) updates the values of the respective HB presence or absence bits (T506-4) of the remote DC table according to the HB presence or absence bit maps (T40-4, T40-5, T40-6) (F504-3).

As illustrated in FIG. 8A, the remote DC table management unit (50-7) activates the respective subtraction counters within the remote DC table, and conducts specific processing (processing within the remote DC counter) if there is a row on which the subtraction counter value becomes 0), in the same manner as that before acting for the HB transmission and reception (F702).

FIG. 8C is a flowchart of the processing in the remote DC counter.

In the above-mentioned specific processing, if the HB transmission and reception are acted (F702-1), the default (T506-2) is loaded into the appropriate subtraction counter (F702-2). If the value of the HB transmission presence or absence bit (T506-4) on the same row in the remote DC table is 1 (HB presence) (F702-3), the HB packet is transmitted to each of the servers within the local DC at the appropriate address of the local DC table (T508) through the DC side HB transmitting unit (50-3) (F702-4). The destination address of the HB packet to be transmitted refers to the local DC side server address within the local DC table (T508-1), and the source address refers to the remote DC side server address (T506-1) within the remote DC table.

Through the above procedure, after the HB packets passing between the distant servers are lumped together for each of the DC sites by the HB-proxy server, the HB packets are transmitted to the counter HB-proxy server of the distant DC site, and transmitted to the respective redundant partner server waiting for the HB packets.

### 3. Sequence

### (1) Assumption

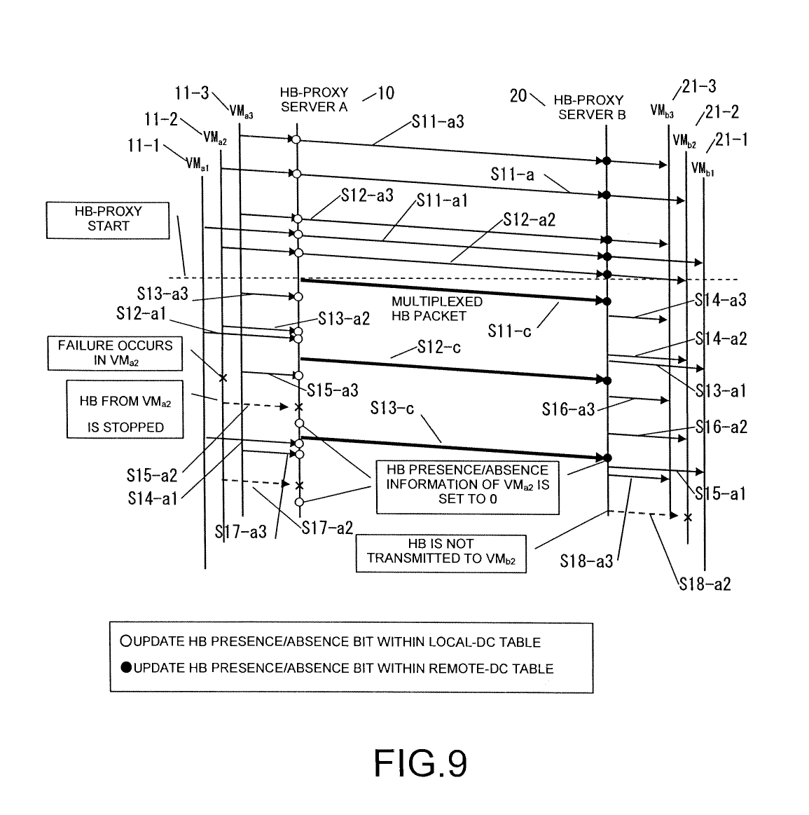

FIG. 9 illustrates a sequence diagram of the above-mentioned embodiment. FIG. 9 illustrates a status in which the virtual machines VMₐ₁ (11-1) VMₐ₂ (11-2), and VMₐ₃ (11-3) of the DC site A (100) are paired with the virtual machines VM_{b1}(21-1), VM_{b2}(21-2), and VM_{b3}(21-3) of the DC site B (200) as the redundant configuration, respectively, and the HB packets are transmitted from the DC site A (100) side to the DC site B (200) side. In FIG. 9, a flow of transmitting the HB packets from the virtual machines within the DC site B (200) to the virtual machines within the DC site A (100) is omitted, and symmetric behavior is really conducted. That is, when the HB packet is transmitted from VMₐ₁ to VM_{b1}, the HB packet is transmitted from VM_{b1} to VMₐ₁.

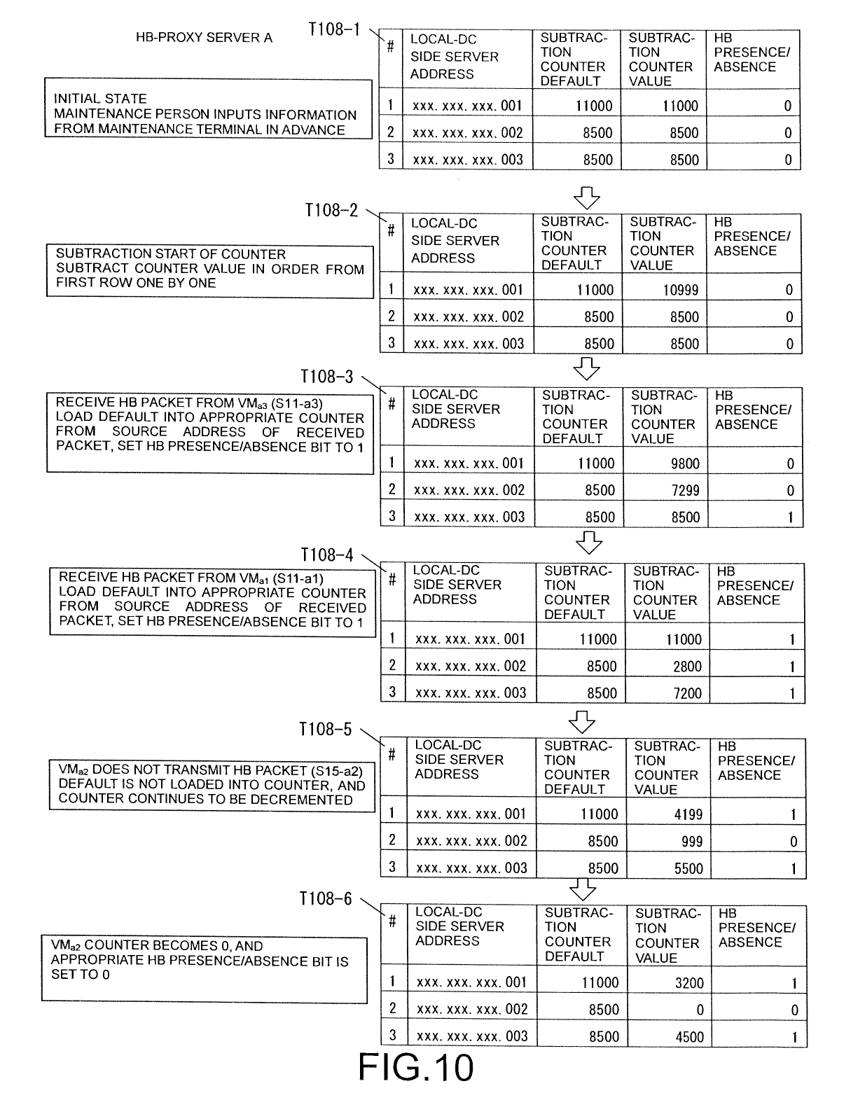

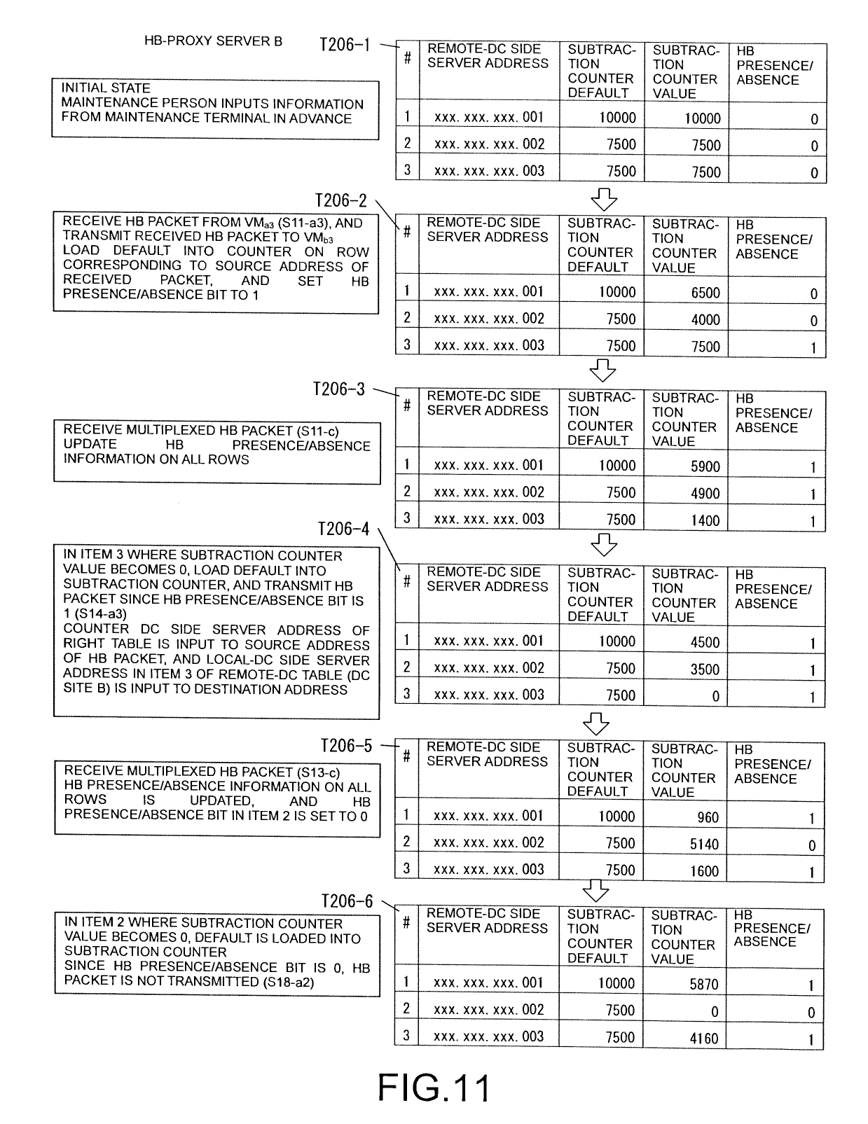

FIGS. 10 and 11 illustrate the transition of the respective tables within the HB-proxy server according to the above embodiment.

The maintenance person has already known the addresses of the respective virtual machines within the DCs and information on the HB transmission cycle, and inputs information on the respective virtual machines and setting information on the HB-proxy server to the HB-proxy server through the maintenance terminal (60). The control unit (50-5) initializes the respective blocks on the basis of the input information. In this example, the control unit (50-5) sets a default of the subtraction counter within the local DC table to HB transmission cycle+1000 counts of the virtual machine within the local DC (T108-1). The control unit (50-5) also sets a default of the subtraction counter within the remote DC table to be the HB transmission cycle of the virtual machine within the remote DC (T108-1).

### (2) Before Acting for HB Transmission and Reception

First, before starting to act for the HB transmission and reception, the local DC table management unit (50-9) and the remote DC table management unit (50-7) within the HB-proxy server A (10) and the HB-proxy server B (20) each decrement the value of the subtraction counter in order from the first row of the table one by one (T108-2). When the HB packet is transmitted from the VMₐ₃(11-1), the HB packet is received by the DC side HB receiving unit (50-1) within the HB-proxy server A, and the received HB packet is transferred to the NW side as it is by the NW side HB transmitting unit (50-2) (S11-a3). In this situation, the local DC table management unit (50-9) of the HB-proxy server A sets the HB presence or absence bit of the VMₐ₃ to 1, and loads the default into the subtraction counter (T108-3). When the HB packet arrives at the HB-proxy server B through the NW, the HB-proxy server B sets the HB presence or absence bit of the VMₐ₃ within the remote DC table HB of the HB-proxy server B to 1, and loads the default into the subtraction counter (T206-2). Subsequently, the HB-proxy server receives the HB packets transmitted in order of VMₐ₂, VMₐ₃, and VMₐ₁ (S11-a2, S12-a3, S11-a1), sets the HB presence or absence bit to 1 in order of VMₐ₂, VMₐ₃, and VMₐ₁, and loads the default into the subtraction counter in order, likewise (T108-4). When the HB packet arrives at the HB-proxy server B through the NW, the updating of the HB presence or absence bit within the remote DC table, and the loading of the default into the subtraction counter are implemented. When the second HB packet transmission of VMₐ₂ is conducted, the above-mentioned flow is repeated. The default is loaded into the subtraction counter, and the HB presence or absence bit is set to 1, on the second rows of the local DC table of the HB-proxy server A and the remote DC table of the HB-proxy server B.

### (3) After Acting for HB Transmission and Reception

i) Normal State

When the maintenance person sets the HB transmission and reception acting start through the maintenance terminal (60), the NW side HB transmitting unit within the HB-proxy server A (10) generates the multiplexed HB packet (T40) on the basis of the HB presence or absence information (T508-4) within the local DC table at regular time intervals set by the maintenance person, and transmits the generated multiplexed HB packet (40) to the HB-proxy server B (20) (S11-c). The multiplexed HB packet is based on the HB presence or absence information updated immediately before the HB transmission and reception acting start.

The NW side HB receiving unit of the HB-proxy server B (20) updates the HB presence or absence information (T506-4) within the remote DC table according to the received multiplexed HB packet (T206-3). When the item 3 of the subtraction counter value in the remote DC table of the HB-proxy server B becomes 0 (T206-4), because the bit value is 1 (HB presence) in the appropriate HB presence or absence bit, the remote DC table management unit transmits the HB packets to the VM_{b3} through the DC side HB transmission unit (S14-a3). Subsequently, the remote DC table management unit transmits the HB packets to the respective virtual machines within the DC site B at a moment when the subtraction counter value in the remote DC table of the HB-proxy server B becomes 0 (S14-a2, S13-a1).

A value of the remote DC side server address of the remote DC table within the HB-proxy server B is input to the source address of the HB packet to be transmitted, and a value of the local DC side server address of the local DC table within the HB-proxy server B is input to the destination address.

Subsequently, when the HB packets are transmitted from the respective virtual machines within the DC site A (s13-a3, s12-a1, s15-a3), the default is loaded into the subtraction counter of the HB-proxy server A, and the HB presence or absence bit is set to 1. The updated HB presence or absence information of the respective virtual machines within the DC site A is lumped by the multiplexed HB packet, and transmitted to the HB-proxy server B (s12-c). The HB-proxy server B sets the respective HB presence or absence bits in the remote DC table to 1 (HB presence) according to the received multiplexed HB packet.

Subsequently, the respective virtual machines within the DC site A (100) transmit the HB packets (S12-a1, S13-a2, S13-a3), the HB-proxy server A updates the local DC table on the basis of the transmitted HB packets, and transmits the updated HB presence or absence information by the multiplexed HB packets (S12-c). The HB-proxy server B updates the HB presence or absence information (T506-4) within the remote DC table according to the received multiplexed HB packets, and transmits the HB packets to the VM_{b2}(21-2) and the VM_{b3} (21-3) (S16-a2, S16-a3).

ii) Failure Occurrence State

When the VMₐ₂ (11-2) fails, the HB packets are not transmitted to the HB-proxy server A (S15-a2, S17-a2), and only the HB packets of VMₐ₁ (11-1) and VMₐ₃ (11-3) are transmitted (S14-a1, S15-a3, S17-a3). When the HB packets are not transmitted from VMₐ₂ (11-2) (S15-a2), the subtraction counter value in the local DC table within the HB-proxy server is not set to the default, but continues to be subtracted (T108-5). When the subtraction counter value continues to be subtracted and becomes 0, the HB presence or absence bit is set to 0 (HB absence) (T108-6). Information that the HB presence or absence bit of VMₐ₂ becomes 0 is transmitted to the HB-proxy server B through the multiplexed HB packet (S13-c).

When the HB-proxy server B receives the multiplexed HB packets, the HB-proxy server B sets the HB presence or absence bit on the second row of the remote DC table to 0 (T206-5). When the subtraction counter on the second row of the remote DC table within the HB-proxy server B becomes 0, because the HB presence or absence bit on the same row is 0, the HB-proxy server B does not transmit the HB packets to VM_{b2} (T206-6). That is, the HB-proxy server B transmits the HB packets to VM_{b1} (21-1) and VM_{b3} (21-3) (S15-a1, S18-a3), but does not transmit the HB packets to VM_{b2} (21-2) (S18-a2).

When a state in which the HB packets are not received by VM_{b2} (20-2) continues for a given time, VM_{b2} (20-2) determines that VMₐ₂ (10-2) fails.

The same procedure is applied to a flow of transmitting the HB packets from the virtual machine within the DC site B to the virtual machine within the DC site A.

### (4) Table

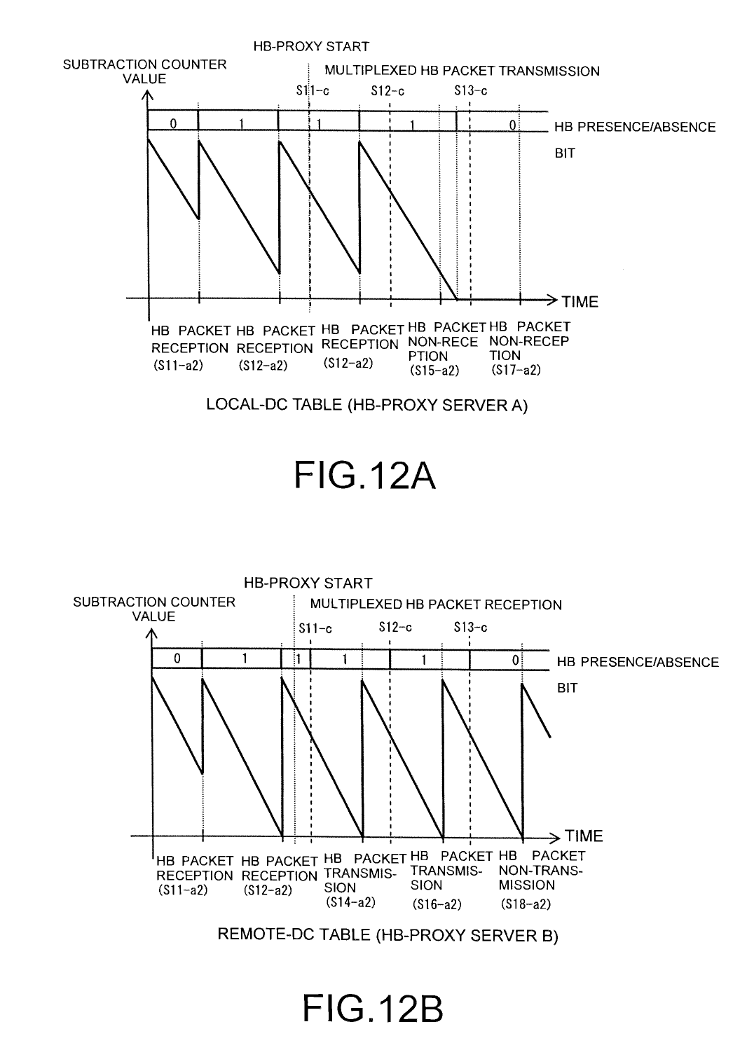

FIG. 12A illustrates an appearance of a change in the subtraction counter value and the HB presence or absence bit in VMₐ₂ of the local DC table within the HB-proxy server A in the above-mentioned sequence. When the HB-proxy server starts to learn the HB presence or absence information, the subtraction counter starts to count. The default of the HB presence or absence bit is 0, and when the HB packet is received from VMₐ₂, the HB presence or absence bit is set to 1, and the default is loaded into the subtraction counter. The HB presence or absence bit is set to 1 every time the HB packet transmitted from VMₐ₂ is received, and the subtraction counter value is also returned to the default. When starting to act for the HB, the HB presence or absence bit values are lumped by the multiplexed packet, and transmitted to the HB-proxy server B. However, the function of the subtraction counter is not changed, and functions as a timer for determining whether there is the HB packet, or not. When the HB packet is not transmitted from VMₐ₂, because the default is not loaded into the counter, the subtraction continues. When eventually the counter value becomes 0, the HB presence or absence bit is set to 0. Because the HB presence or absence bit value is to be maintained at 1 while the HB packets are transmitted from VMₐ₂, there is a need to set a cycle of the counter to be longer than the transmission cycle of the HB packet. In this embodiment, a time obtained by adding 1000 counts to the transmission cycle is set as the count cycle.

FIG. 12B illustrates an appearance of a change in the subtraction counter value and the HB presence or absence bit in VMₐ₂ of the remote DC table within the HB-proxy server B in the above-mentioned sequence. When the HB-proxy server starts to learn the HB presence or absence information, the subtraction counter starts to count. The default of the HB presence or absence bit is 0, and when the HB packet is received from VMₐ₂, the HB presence or absence bit is set to 1, and the default is loaded into the subtraction counter. The HB presence or absence bit is set to 1 every time the HB packet transmitted from VMₐ₂ is received, and the subtraction counter value is also returned to the default. Therefore, the subtraction counter functions as a timer for determining whether there is the HB packet, or not. When starting to act for the HB, the HB presence or absence bit values are lumped by the multiplexed packet and transmitted from the HB-proxy server A, and the value of the HB presence or absence bit value is updated. When the subtraction counter value becomes 0, the subtraction counter value returns to the default. The HB presence or absence bit is confirmed, and if the bit value is 1, the HB packet is transmitted to VM_{b2}. Therefore, the subtraction counter during HB-proxy functions as a timer for measuring the transmission cycle of the HB packet. On the other hand, if the bit value is 0, the HB packet is not transmitted to VM_{b2}.

### B. Second Embodiment

### 1. System

In this embodiment, a description will be given of a method applied to a system in which one of m pairs of servers redundantly configured transmits an HB request packet to the other, and if the server is normal, the server returns an HB reply packet to the request source.

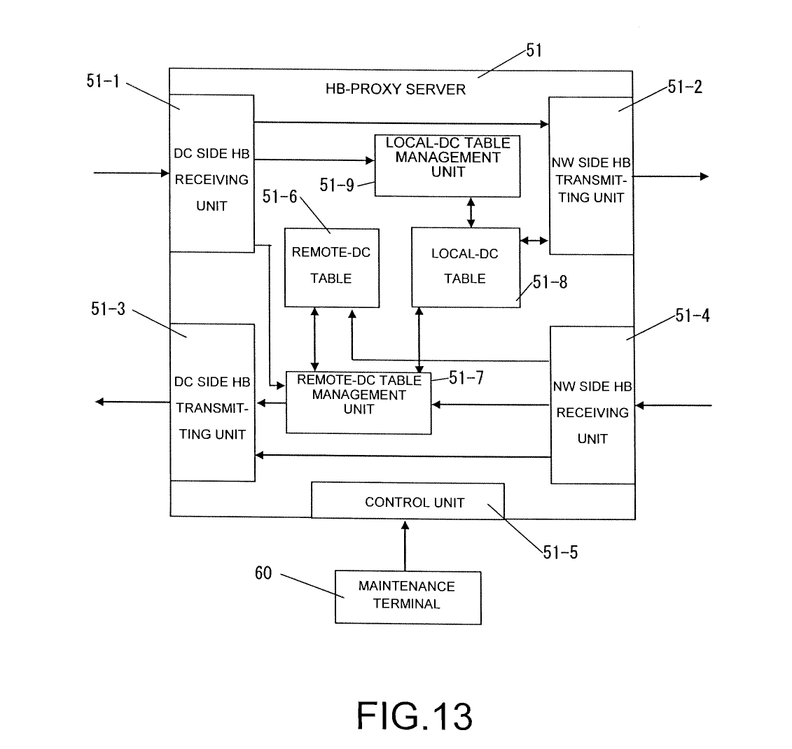

FIG. 13 illustrates an HB-proxy server according to a second embodiment. An HB-proxy server (51) includes a DC side HB receiving unit (51-1), a DC side HB transmitting unit (51-3), an NW side HB transmitting unit (51-2), an NW side HB receiving unit (51-4), a local DC table management unit (51-9), a local DC table (51-8), a remote DC table management unit (51-7), a remote DC table (51-6), and a control unit (51-5).

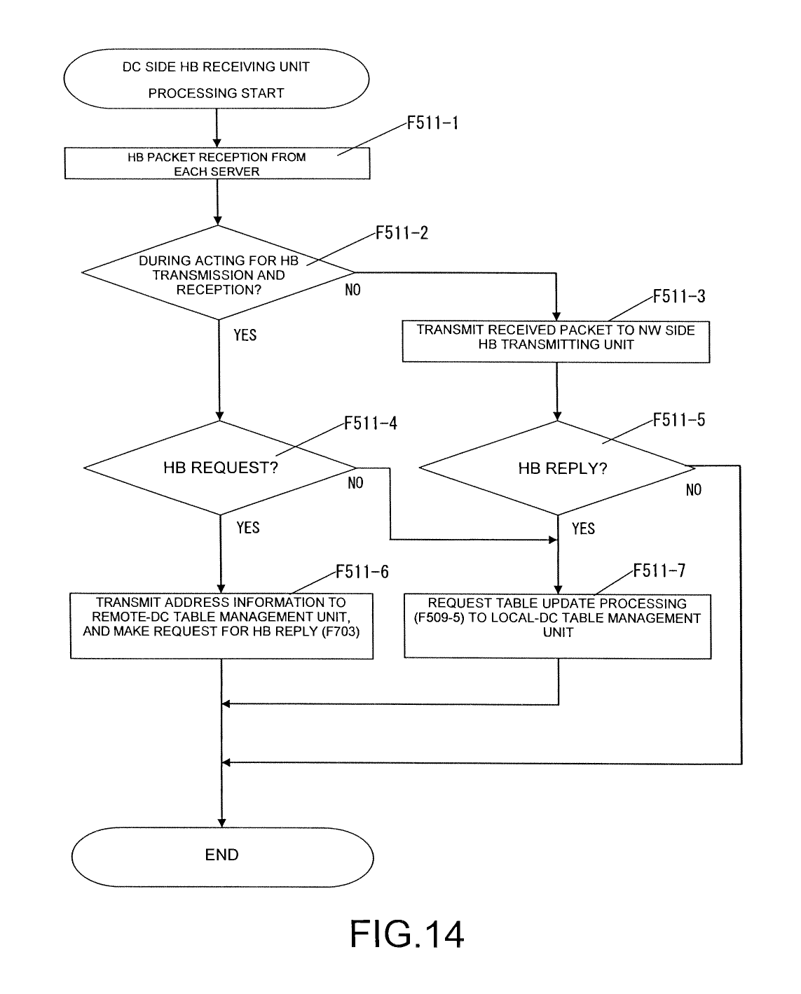

The DC side HB receiving unit (51-1) is a block that receives the HB packets transmitted from the DC site to the NW side between the sites. As illustrated in a flowchart of FIG. 14 (which will be described in detail later), before acting for the HB transmission and reception, the DC side HB receiving unit (51-1) transfers the received HB packet to the NW side HB transmitting unit (51-2). If the received HB packet is the HB reply packet, the DC side HB receiving unit (51-1) requests the local DC table update processing to the local DC table management unit (51-9). Also, the DC side HB receiving unit (51-1) receives the request packet during acting for the HB transmission and reception, the DC side HB receiving unit (51-1) requests the processing to the remote DC side table management unit so as to transmit the HB reply to the appropriate server within the local DC site. When receiving the reply packet, the DC side HB receiving unit (51-1) requests the local DC table update processing to the local DC table management unit (51-9) in the same manner as that before acting for the HB transmission and reception.

The local DC tables (51-8, T508) are tables in which HB information of the respective servers within the local DC site is recorded, and as illustrated in FIG. 3A, stores addresses of the respective servers within the local DC site (T508-1), defaults (T508-2) of a subtraction counter, subtraction counter values (T508-3) for counting time until it is determined that there is no HB transmission, and HB reception presence or absence information (T508-4) of the HB-proxy server, correspondingly. As the server addresses of the respective tables, the addresses of the physical servers may be used, or the addresses of the VM may be used. In the subtraction counter values (T508-3), when the HB reply packet is received, the default (T508-2) is loaded, and a countdown is continued until the subsequent HB reply packet is received, or the count value becomes 0. When the HB-proxy server gets out of receiving the HB packet, the count value becomes 0. This leads to the determination that there is no HB packet.

The local DC table management unit (51-9) is a block that updates the local DC table. As illustrated in FIG. 6, the local DC table management unit (51-9) receives a request for the local DC table update processing from the DC side HB receiving unit (51-1), searches the table from a source address of a received HB reply packet, and rewrites the appropriate HB reception presence or absence information. Also, the local DC table management unit (51-9) also updates values of the respective subtraction counters within the local DC table (51-8).

The NW side HB transmitting unit (51-2) is a block that transmits the HB packet to the NW side from the HB-proxy server. The NW side HB transmitting unit (51-2), as illustrated in a flowchart of FIG. 5, transmits the HB packet transferred from the DC side HB receiving unit (51-1) to the NW side before acting for the HB packet transmission and reception. Also, the NW side HB transmitting unit (51-2) refers to the respective HB information of the local DC table (51-8) while acting for the HB packet transmission and reception, generates the Multiplexed HB packet (40), and transmits the generated Multiplexed HB packet (40) to the counter HB-proxy server.

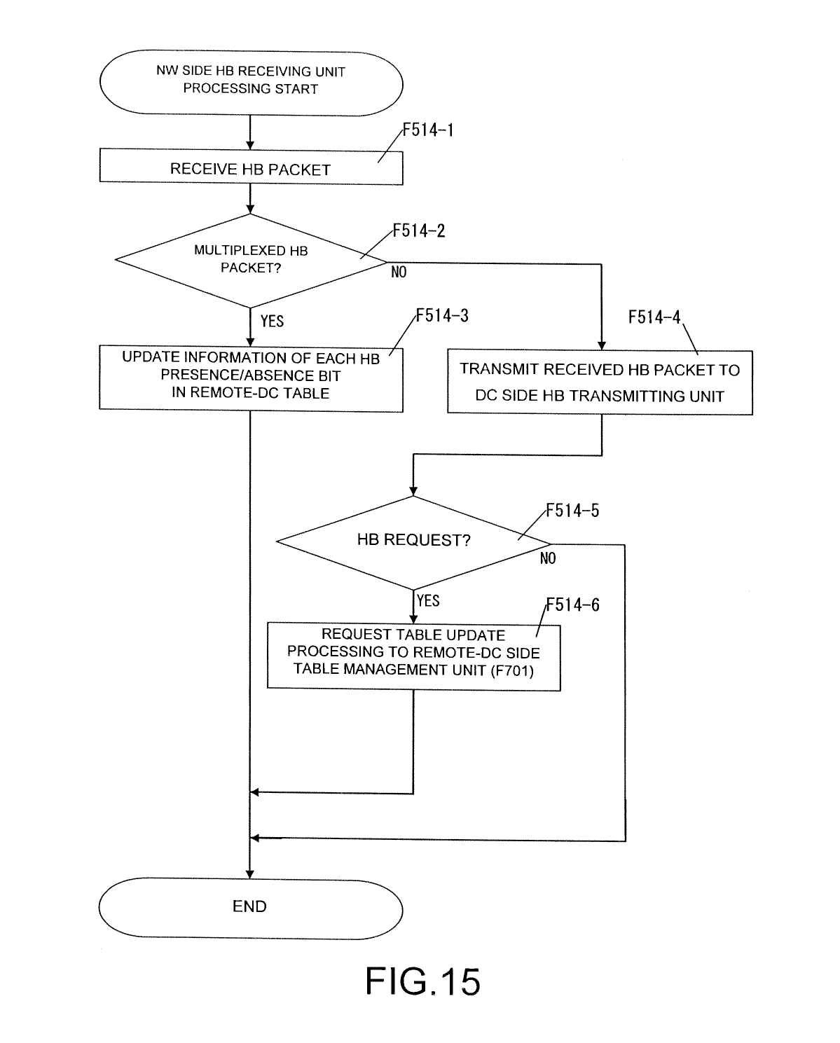

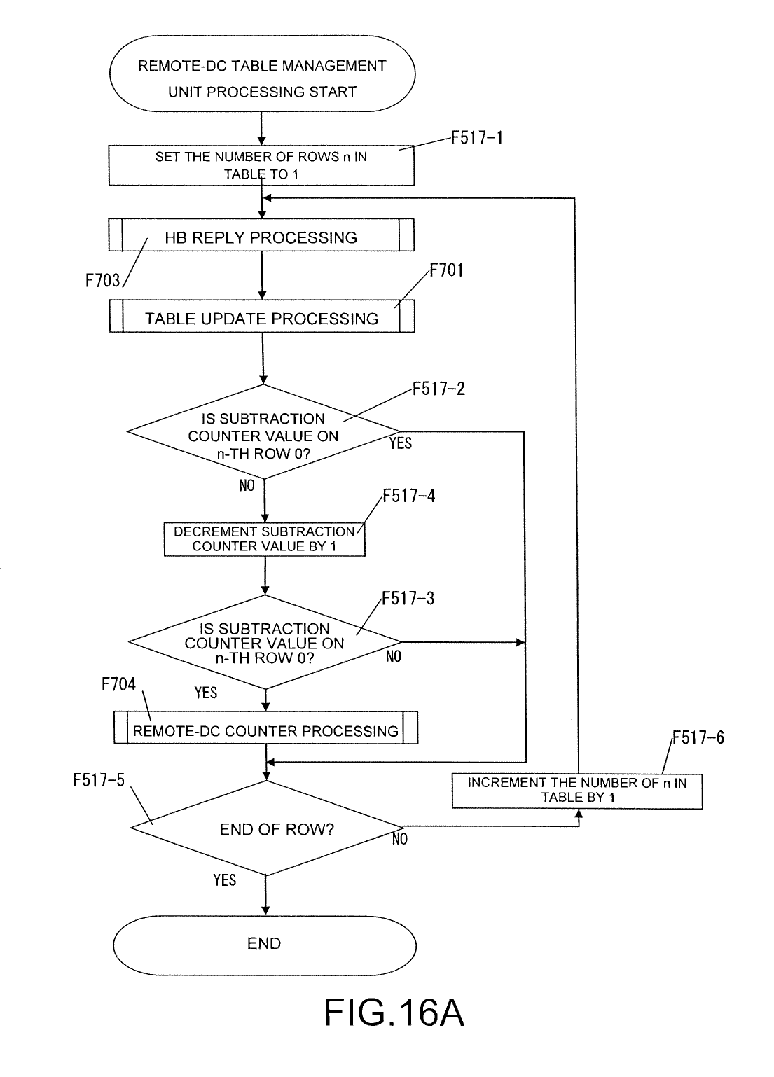

The NW side HB receiving unit (51-4) is a block that receives the packet transmitted from the NW side. As illustrated in the flowchart of FIG. 15 (which will be described in detail later), the NW side HB receiving unit (51-4) distinguishes the received HB packets between the normal HB packet and the Multiplexed HB packet, transfers the received HB packet to the DC side HB transmitting unit (51-3) if the received HB packet is the normal HB packet, and requests the remote DC table (51-6) update processing to the remote DC table management unit (51-7) if the received HB packet is the HB request packet in particular. If the received HB packet is the Multiplexed HB packet, the NW side HB receiving unit (51-4) directly updates the HB reception presence or absence information of the remote DC table (51-6) on the basis of the received data.

The remote DC tables (51-7, T507) are tables in which the HB information of the respective servers within the redundant remote DC site is recorded, and as illustrated in FIG. 3B, stores addresses of the respective servers within the remote DC site (T506-1), defaults (T506-2) of a subtraction counter, subtraction counter values (T506-3) for counting a specific time, and HB transmission presence or absence information (T506-4), correspondingly. As the server addresses of the respective tables, the addresses of the servers may be used, or the addresses (address of VM) of the server including the addresses of the VM may be used. In the subtraction counter values (T506-3), before acting for the HB transmission and reception, when the HB request packet is received, the defaults (T50-2) is loaded, and a countdown is continued until the subsequent HB request packet is received, or the count value becomes 0. When the HB-proxy server gets out of receiving the HB request packet, the count value becomes 0. This leads to the determination that there is no HB packet, and the HB-proxy server functions as a timer since receiving the HB request packet till the determination that there is no HB transmission. After acting for the HB packet transmission and reception, the subtraction counter by the subtraction counter values (T506-3) functions as a timer announcing times at which the HB request packets are transmitted to the respective servers within the local DC site, and the defaults are loaded into the subtraction counter every time the HB request packets are transmitted.

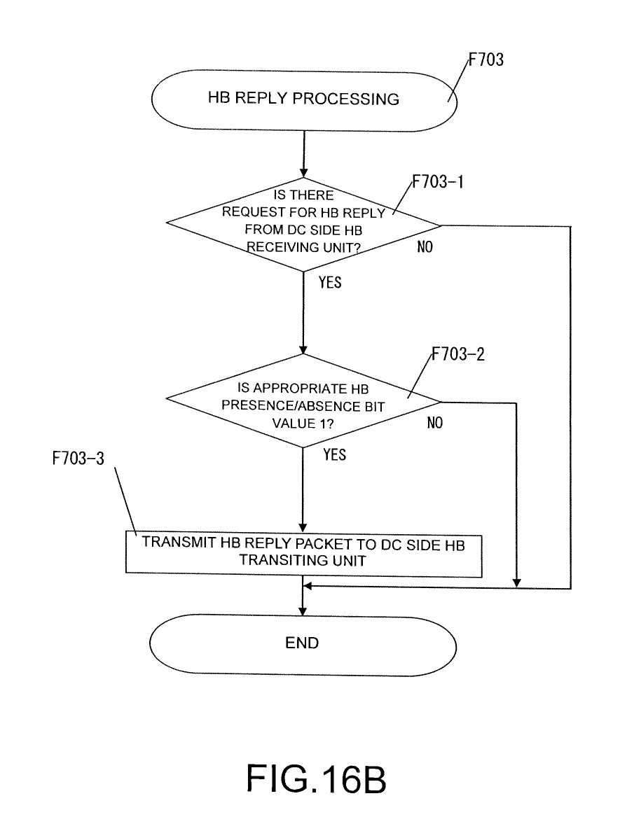

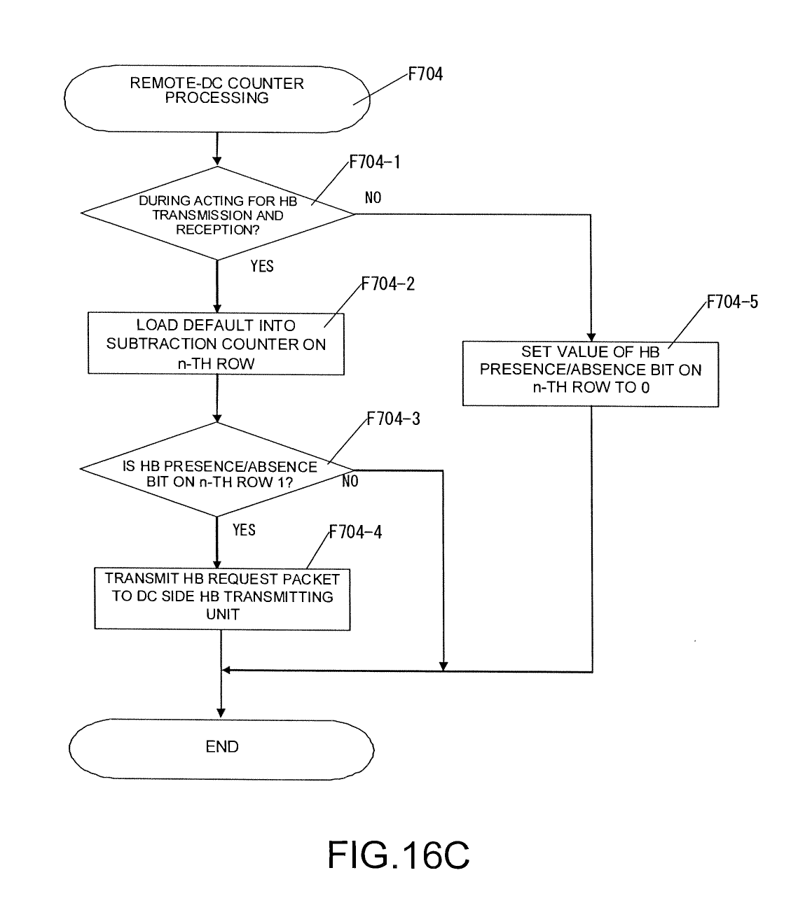

The remote DC table management unit (51-7) is a block that updates the remote DC table. As illustrated in flowcharts of FIGS. 8B, 16A, 16B and 16C (which will be described in detail later), the remote DC table management unit (51-7) receives a request for the remote DC table update processing from the NW side HB receiving unit (50-4) before acting for the HB packet transmission and reception, searches the table from the source address of the received HB reply packet, and rewrites the appropriate HB reception presence or absence information. While acting for the HB packet transmission and reception, the remote DC table management unit (51-7) transmits the HB request packets to the DC side HB transmitting unit in a cycle of the subtraction counter. Also, the remote DC table management unit (51-7) also updates values of the respective subtraction counters within the remote DC table (51-8) regardless of whether to act for the HB packet transmission and reception, or not.

The DC side HB transmitting unit (51-3) is a block that transmits the HB packet to the respective servers within the local DC, and as illustrated in FIG. 7B, the DC side HB transmitting unit (51-3) transmits the HB packets transmitted from the NW side HB receiving unit (51-4) and the remote DC table management unit (51-7) to the respective servers within the local DC.

A maintenance terminal (60) is used for initializing the local DC table (51-8) and the remote DC table (51-6) and setting the transmission interval of the Multiplexed HB packet and pairs of the redundant configuration. Also, the HB transmission and reception acting start is conducted by setting the maintenance terminal (60).

The control unit (51-5) is a block that actually sets the respective setting values input by a maintenance person through the maintenance terminal (60) for the respective units of the HB-proxy server.

### 2. Operation Flow

### (1) Assumption

A description will be given of the respective function blocks with reference to FIGS. 5, 6, 7B, 8B, 14, 15, 16A, 16B and 16C. Processing illustrated in FIGS. 5, 6, 14, 15 and 16A shows only one processing, but in fact the processing of the flowcharts is repetitively executed.

Before operating the HB-proxy server, the maintenance person sets information on the servers redundantly configured between the data centers for the local DC table (T508) and the remote DC table (T506). In more detail, for example, the addresses of the respective servers redundantly configured within the local data center and the counter data center are registered, and the defaults of the subtraction counter are set. Also, the subtraction counter values are set to 0, the HB presence or absence bit are set to 0 (HB absence), and the transmission cycle of the Multiplexed HB packet and the pairs redundantly configured are set. However, in this embodiment, for simplification, it is assumed that a server corresponding to an n-th row of the local DC table (T508) and a server corresponding to an n-th row of the remote DC table (T506) are paired as the redundant configuration. As the server addresses of the respective tables, the address of the physical server may be used, or the address of the VM may be used.

When the default is completed by the maintenance person, the HB-proxy server monitors the HB packets transmitted from the respective servers, and transfers the HB packets to the network side until receiving an instruction to act for the HB transmission and reception from the maintenance person, in order to learn the HB presence or absence information in the local DC table and the remote DC table.

When the server within the local DC site transmits the HB packet to the redundant system server of the remote DC site, the DC side HB receiving unit of the HB-proxy server receives the HB packet.

As illustrated in FIG. 3C, the HB packet HB packets (T41) includes the source address (T41-1), the destination address (T41-2), information (T41-3) indicating whether the HB packet is the HB request packet or the HB reply packet, and the other header information (T41-4) depending on a protocol.

(2) Before acting for HB transmission and reception

i) Transmission of Request Packet to NW

When each of the servers transmits the HB request packet to the NW between the sites, the DC side HB receiving unit receives the HB request packet.

FIG. 14 is a flowchart of the processing in the DC side HB receiving unit.

Before acting for the HB transmission and reception, in order that the HB-proxy server monitors the HB packet and updates the table, the DC side HB receiving unit transmits the received HB request packet to the NW side HB transmitting unit as it is (F511-1, F511-2, F511-3). As illustrated in FIG. 5, the NW side HB transmitting unit transmits the HB request packet to the counter HB-proxy server through the NW between the sites (F502-3).

ii) Reception of HB Request Packet from NW

FIG. 15 is a flowchart of the processing in the NW side HB receiving unit.

The HB request packet that has arrived at the acting server through the NW between the sites is received by the NW side HB receiving unit. The NW side HB receiving unit identifies the type of the received HB packet (F514-2). If the NW side HB receiving unit determines that the received HB packet is a normal HB request packet (F514-5), the NW side HB receiving unit requests the update processing of the FIB presence or absence bit of the HB request packet source within the remote DC table to the remote DC side table management unit (F514-6), and transfers the received HB request packet to the DC side HB transmitting unit (F514-4).

As illustrated in FIG. 7B, the DC side HB transmitting unit transmits the received HB packet to the redundant partner server (F503-1).

iii) HB Reply Packet Transmission

The redundant target server returns the HB reply packet in a normal state, and as illustrated in FIG. 14, the reply packet is received by the DC side HB receiving unit of the acting server (F511-1).

Upon receiving the HB reply packet (F511-2, F511-3, F511-5), the DC side HB receiving unit requests the update processing of the HB presence or absence bit of the HB reply packet source within the local DC table to the local DC management unit (F511-7), and transfers the received HB reply packet to the NW side HB transmitting unit (F511-3).

As illustrated in FIG. 5, the NW side HB transmitting unit transmits the HB reply packet to the counter HB-proxy server through the NW between the sites (F502-3).

As illustrated in FIG. 6, upon receiving the local DC table update request from the DC side HB receiving unit (F509-6), the local DC table management unit, searches the local DC table on the basis of the source address of the received HB reply packet. The local DC table management unit then sets the HB presence or absence bit on an appropriate row of the local DC table to 1 (HB presence), and loads the default into the subtraction counter value (F509-7). Also, if the subtraction counter value on a certain row of the local DC table is not 0 (F509-2), the local DC table management unit decrements the subtraction counter value on the same row by one (F509-3). If the decremented result is 0 (F509-4), the local DC table management unit sets the HB presence or absence bit on the same row to 0 (HB absence) (F509-5). The local DC table management unit repeats the above-mentioned counter subtraction processing till a final row of the table (F509-8, F509-9).

iv) HB Reply Packet Reception

The HB reply packet that has arrived at the acting server through the NW between the sites is received by the NW side HB receiving unit. As illustrated in FIG. 15, the NW side HB receiving unit identifies the type of the received HB packet. If the NW side HB receiving unit determines that the received HB packet is a normal HB reply packet (F514-2), the NW side HB receiving unit transfers the received HB packet to the DC side HB transmitting unit (F514-4).

As illustrated in FIG. 7B, the DC side HB transmitting unit checks an address of the receive packet, and transmits the received packet to an appropriate server within the DC as it is, regardless of whether the HB transmission and reception are being acted, or not (F503-1).

As illustrated in FIG. 8B, if there is a request for the remote DC table update processing (F701) from the NW side HB receiving unit (F701-1), the remote DC table management unit (50-7) sets the HB presence or absence bit of the HB packet source on an appropriate row of the remote DC table to 1 (HB presence) on the basis of the source address of the received HB reply packet, and loads the default in the subtraction counter on the same row (F701-2).

FIG. 16A is a flowchart of the processing in the remote DC table management unit. Also, FIG. 16C is a flowchart of the processing in the remote DC table management unit.

Also, the remote DC table management unit decrements the counter value in order from a first row (F517-1) of the remote DC table one by one (F517-4). If the subtraction counter value of a certain row in the remote DC table is not 0 (F517-2), the remote DC table management unit decrements the subtraction counter value by one. If the decremented result is 0 (F517-3), the remote DC table management unit sets the HB presence or absence bit on the same row to 0 (HB absence) (F704, F704-5 in FIG. 16C). The remote DC table management unit repeats the above-mentioned counter subtraction processing till a final row of the table (F517-5, F517-6).

### (3) After Acting for HB Transmission and Reception

i) HB Reply Packet Return to HB Request Packet from Local Server

If the HB transmission and reception acting starts by setting of the maintenance person, and the HB request packet is transmitted from the server within the local DC, as illustrated in FIG. 14, the DC side HB receiving unit (51-1) receives the HB request packet (F511-4), and requests the remote DC table management unit to return the reply packet to the server of the HB request packet source (F511-6).

FIG. 16B is a flowchart of the processing in the remote DC table management unit.

Upon receiving the request from the DC side HB receiving unit (F703, F703-1), the remote DC table management unit returns the HB reply packet to the server through the DC side HB transmitting unit (F703-3) if the bit value of the appropriate HB presence or absence bit is 1 (F703-2), and returns nothing if the bit value is 0 (F703-2).

Also, as illustrated in FIG. 16A, the remote DC table management unit (51-7) activates the respective subtraction counters within the remote DC table, and conducts specific processing (F704) if there is a row on which the subtraction counter value becomes 0 (F517-3), in the same manner as that before acting for the HB transmission and reception. As illustrated in FIG. 16C, in the specific processing during acting for the HB transmission and reception (F704-1), the default (T506-2) is loaded into the appropriate subtraction counter (F704-2). If the HB presence or absence bit on the same row is 1 (F704-3), the HB request packet is transmitted to each of the servers within the local DC at the appropriate address of the local DC table (T508) through the DC side HB transmitting unit (50-3) (F704-4). The destination address of the HB request packet refers to the local DC table (T508), and the source address refers to the remote DC table.

ii) Multiplexed HB Packet Return to HB Request Packet from Counter Server

As illustrated in FIG. 14, if the server within the local DC which has received the HB request packet is normal, the reply packet is returned to the source address of the HB request packet. The HB reply packet is received by the DC side HB receiving unit of the HB-proxy server, and the DC side HB receiving unit requests the table update to the local DC table management unit (F511-1, F511-2, F511-4, F511-7).

As illustrated in FIG. 6, upon receiving the table update request from the DC side HB receiving unit, the local DC table management unit sets the HB reception presence or absence bit (T508-4) of the local DC table (T508-4) corresponding to the source address of the received HB reply packet to 1 (HB presence), and loads the default (T508-2) into the subtraction counter (T508-3) (F509-3).

As illustrated in FIG. 5, the NW side HB transmitting unit (51-2) reads the values of the respective HB presence or absence bits (T508-4) of the local DC table, creates an HB presence or absence bit map, and transmits the created HB presence or absence bit map to the counter acting server as the multiplexed HB packet (T40) (F502-2).

iii) Multiplexed HB Packet Reception

As illustrated in FIG. 15, upon receiving the multiplexed HB packet (T40), the NW side HB receiving unit (51-1) updates the values of the respective HB presence or absence bits (T506) of the other DC tables according to the HB presence or absence bit map (F514-3).

As described in “i) HB reply packet return to HB request packet from local server”, upon receiving the request from the DC side HB receiving unit (F703, F703-1), the remote DC table management unit refers to the other updated DC tables, and returns the HB reply packet to the server through the DC side HB transmitting unit (F703-3) if the bit value of the appropriate HB presence or absence bit is 1 (F703-2), and returns nothing if the bit value is 0 (F703-2).

Through the above procedure, the HB-proxy server can act for a sequence of operation such that the HB request packet is transmitted between the distant servers, and the HB reply packet is returned from the distant redundant partner server.

### 3. Sequence

### (1) Assumption

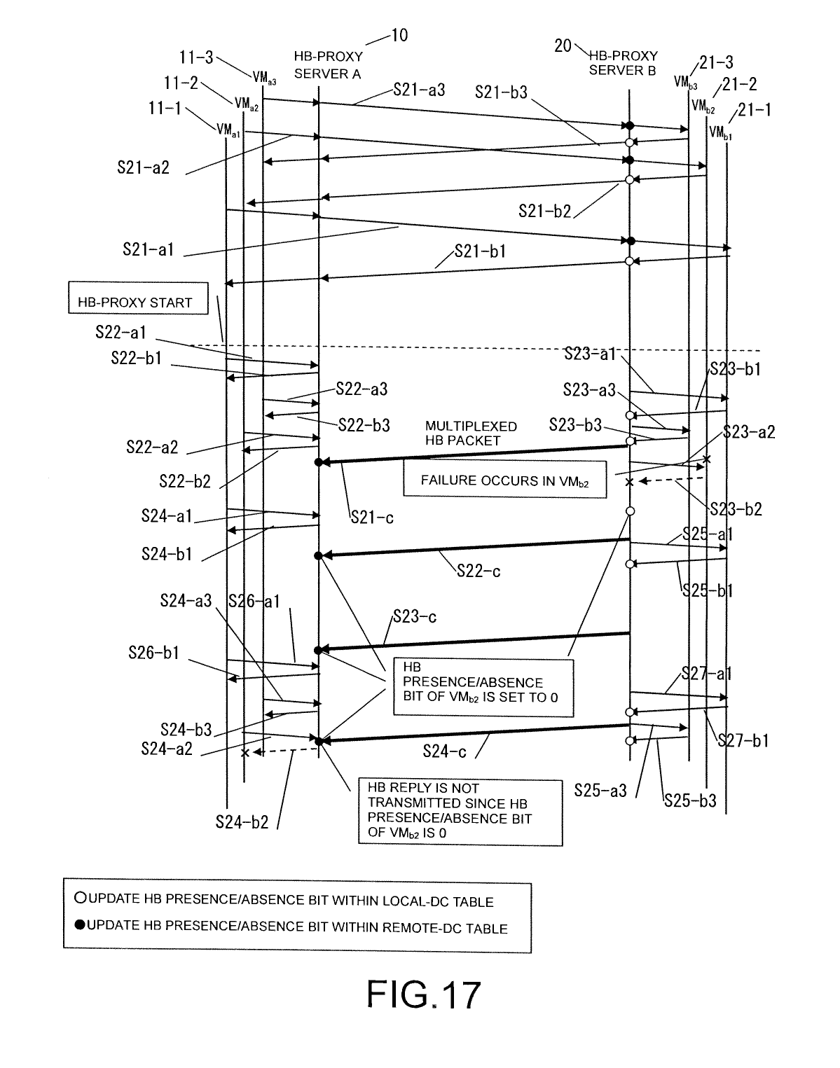

FIG. 17 illustrates a sequence diagram of the above-mentioned embodiment. FIG. 17 illustrates a status in which the virtual machines VMₐ₁ 11-1), VMₐ₂ (11-2), and VMₐ₃ (11-3) of the DC site A (100) are paired with the virtual machines VM_{b1} (21-1), VM_{b2}(21-2), and VM_{b3}(21-3) of the DC site B (200) as the redundant configuration, respectively. In the status, the HB request packets are transmitted from the virtual machines within the DC site A (100) to the virtual machines within the DC site B (200), and if the virtual machines that have received the HB request packets are normal, the virtual machines within the DC site B (200) return the reply packets to the redundant partner virtual machines within the DC site A (100). In FIG. 17, a flow of transmitting the HB request packets from the virtual machines within the DC site B (200) side to the DC site A (100) side, and returning the reply packets if the virtual machines of the destination are normal is omitted. In fact, symmetric behavior is conducted. That is, when the HB request packet is transmitted from VMₐ₁ to VM_{b1}, the HB request packet is transmitted from VM_{b1} to VMₐ₁.

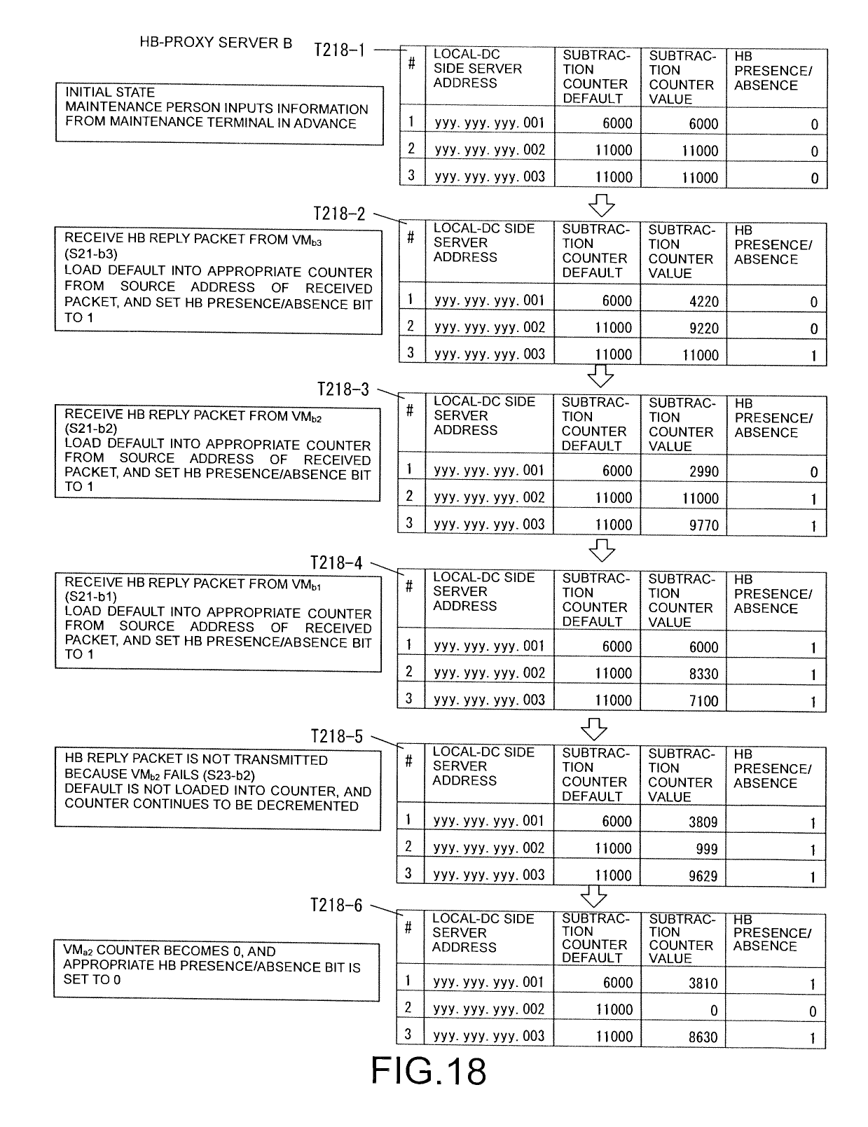

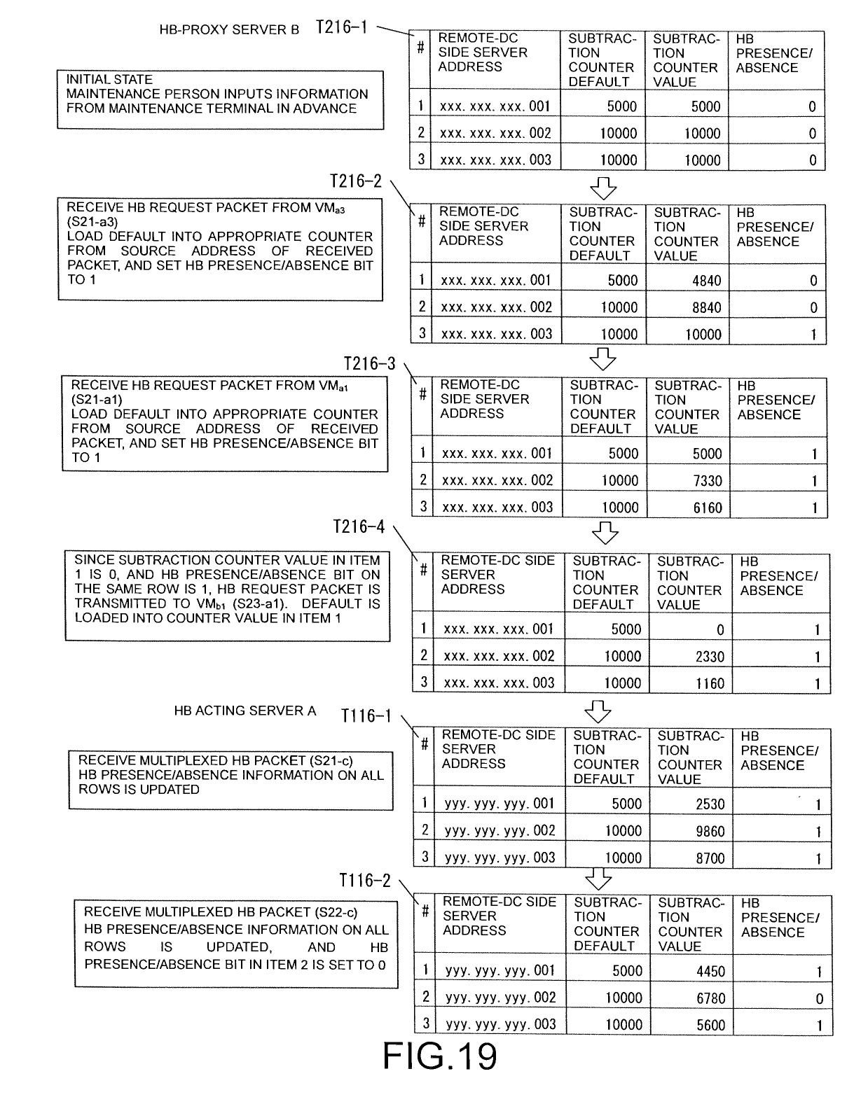

FIGS. 18 and 19 illustrate the change of the respective tables within the HB-proxy server according to the above embodiment.

The maintenance person has already known the addresses of the respective virtual machines within the DCs and information on the HB transmission cycle, and inputs information on the respective virtual machines and setting information on the HB-proxy server to the HB-proxy server through the maintenance terminal (60). The control unit (51-5) initializes the respective blocks on the basis of the input information. In this example, the control unit (51-5) sets a default of the subtraction counter within the local DC table to HB transmission cycle+1000 counts of the virtual machine within the remote DC (T218-1). The control unit (51-5) also sets a default of the subtraction counter within the remote DC table to be the HB transmission cycle of the virtual machine within the remote DC (T216-1).

### (2) Before Acting for HB Transmission and Reception

First, before starting to act for the HB transmission and reception, the local DC table management unit (51-9) and the remote DC table management unit (51-7) within the HB-proxy server A (10) and the HB-proxy server B (20) each decrement the value of the subtraction counter in order from the first row of the table one by one.

When the HB request packet is transmitted from the VMₐ₃ (11-1), the HB packet is received by the DC side HB receiving unit (51-1) within the HB-proxy server A, and the received HB packet is transferred to the NW side as it is by the NW side HB transmitting unit (51-2) (S21-a3).

When the HB request packet arrives at the HB-proxy server

B through the NW, the HB-proxy server B sets the HB absence bit of the VMₐ₃ within the remote DC table HB of the HB-proxy server B to 1, and loads the default into the subtraction counter (T216-2). Subsequently, the HB-proxy server B transmits the received HB request packet to VM_{b3} as it is. Since VM_{b3} is normal, the HB reply packet is transmitted to VMₐ₃ upon receiving the HB request packet (S21-b3). Once the HB reply packet transmitted from VM_{b3} is received by the DC side HB receiving unit within the HB-proxy server B, the local DC table management unit sets the HB presence or absence bit of VM_{b3} to 1, and loads the default into the appropriate subtraction counter (T218-2).

Likewise, VMₐ₂ (11-2) transmits the HB request packet, the DC side HB receiving unit (51-1) within the HB-proxy server A receives the HB request packet, and the NW side HB transmitting unit (51-2) transfers the received HB packet to the NW side as it is (S21-a2). When the HB request packet arrives at the HB-proxy server B through the NW, the HB-proxy server B sets the HB absence bit of the VMₐ₂ within the remote DC table HB of the HB-proxy server B to 1, and loads the default into the subtraction counter. Subsequently, the HB-proxy server B transmits the received HB request packet to VM_{b2} as it is. Since VM_{b2} is normal, the HB reply packet is transmitted to VMₐ₂ upon receiving the HB request packet (S21-b2). Once the HB reply packet transmitted from VM_{b2} is received by the DC side HB receiving unit within the HB-proxy server B similarly, the local DC table management unit sets the HB presence or absence bit of VM_{b2} to 1, and loads the default into the appropriate subtraction counter (T218-3).

Likewise, VMₐ₁ (11-2) transmits the HB request packet, the DC side HB receiving unit (51-1) within the HB-proxy server A receives the HB request packet, and the NW side HB transmitting unit (51-2) transfers the received HB packet to the NW side as it is (S21-a1). When the HB request packet arrives at the HB-proxy server B through the NW, the HB-proxy server B sets the HB absence bit of the VMₐ₁ within the remote DC table HB of the HB-proxy server B to 1, and loads the default into the subtraction counter (T216-3). Subsequently, the HB-proxy server B transmits the received HB request packet to VM_{b1} as it is. Since VM_{b1} is normal, the HB reply packet is transmitted to VMₐ₁ upon receiving the HB request packet (S21-b1).

Once the HB reply packet transmitted by VM_{b1} is received by the DC side HB receiving unit within the HB-proxy server B, the local DC table management unit sets the HB presence or absence bit of VM_{b1} to 1, and loads the default into the appropriate subtraction counter (T218-4).

### (3) After Acting for HB Transmission and Reception

i) Normal State

When the maintenance person sets the HB transmission and reception acting start through the maintenance terminal (60), the NW side HB transmitting unit within the HB-proxy server B (20) generates the multiplexed HB packet (T40) on the basis of the HB presence or absence information (T508-4) within the local DC table at the regular time intervals set by the maintenance person, and transmits the generated multiplexed HB packet (T40) to the HB-proxy server A (10) (S21-c). The multiplexed HB packet is based on the HB presence or absence information updated immediately before the HB transmission and reception acting start. Therefore, when the HB request packets are transmitted from the respective virtual machines within the DC site A (S22-a1, S22-a3, S22-a2), the remote DC table management unit within the HB-proxy server A generates the HB reply packet on the basis of the information before acting for HB (F704-4), and transmits the generated HB reply packet from the DC side HB transmitting unit to the respective virtual machines (F503-1, S22-b1, S22-b3, S22-b2).

On the other hand, when the VM_{b1} subtraction counter corresponding to VMₐ₁ of the remote DC table within the HB-proxy server B becomes 0, the default is loaded into the counter, and if the appropriate HB presence or absence bit is 1, the HB request packet is transmitted to VM_{b1} (S23-a1, T216-4). Upon receiving the HB request packet, VM_{b1} transmits the HB reply packet to VMₐ₁ (S23-b1). Similarly, in each of VM_{b3} and VM_{b2}, when the subtraction counter of the remote DC table within the HB-proxy server B becomes 0, if the appropriate HB presence or absence bit is 1, the default is loaded into the counter, and the HB request packet is transmitted to VM_{b3} and VM_{b2} (F704-4, F503-1, S23-a3, S23-a2).

ii) Failure Occurrence State

Now, it is assumed that a failure occurs in VM_{b2}. In this case, because VM_{b1} and VM_{b3} are normal, the HB reply packet is returned (S23-b3), but because VM_{b2} fails, the HB reply packet is not returned (S23-b2). Because the HB reply packet is not returned from VM_{b2}, the default is not loaded into the VM_{b2} subtraction counter of the local DC table within the HB-proxy server B (T218-5).

Because the default is not loaded into the VM_{b2} subtraction counter, the subtraction counter value becomes 0 after a given time, and 0 is set to the HB presence or absence bit (F509-4, T218-6).

On the other hand, when the multiplexed HB packet is received by the NW side HB receiving unit within the HB-proxy server A, the HB presence or absence information (T506-4) of the remote DC table within the HB-proxy server A is updated (S21-c, T116-1).

When VMₐ₁ transmits the HB request packet to VM_{b1} (S24-a1), the DC side HB receiving unit within the HB-proxy server A receives the HB request packet, and the remote DC table management unit checks information of the updated remote DC table, and returns the HB reply packet from the DC side HB transmitting unit if the HB presence or absence bit is 1 (S24-b1).

Subsequently, the multiplexed HB packet is transmitted from the HB-proxy server B to the HB-proxy server A (S22-c), since the HB presence or absence information of VM_{b2} is 0 (HB absence), the VM_{b2} HB presence or absence bit of the remote DC table within the HB-proxy server A is set to 0 (T116-2).

When the HB request packets are transmitted from the respective virtual machines within the DC site A (S26-a1, S24-a3, S24-a2), the HB-proxy server A refers to the HB presence or absence bit of the remote DC table within the HB-proxy server A, and transmits the HB reply packet to VMₐ₁ and VMₐ₃ (S26-b1, S24-b3), but does not transmit the HB reply packet to VMₐ₂ (S24-b2).

Even if VMₐ₂(11-2) makes the HB request, if a status in which the reply packet is not returned continues for a given time, it is determined that VM_{b2}(21-2) fails.

### (4) Table

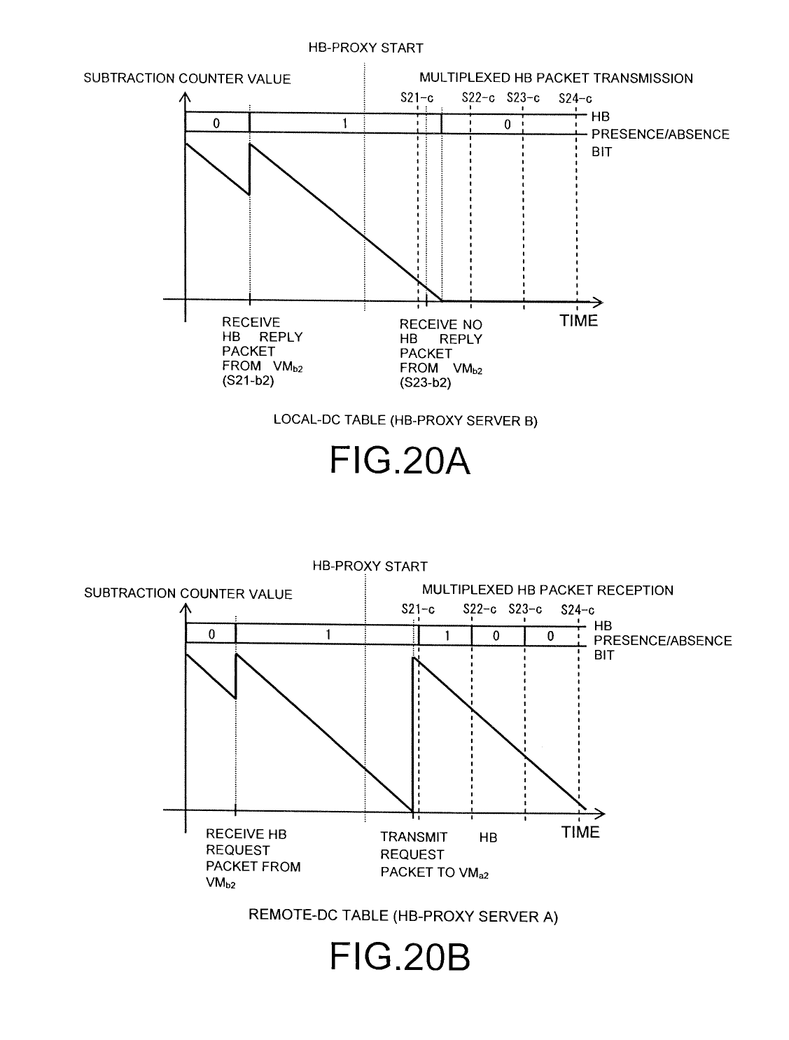

FIG. 20A illustrates an appearance of a change in the subtraction counter value and the HB presence or absence bit in VM_{b2} of the local DC table within the HB-proxy server B in the above-mentioned sequence. When the HB-proxy server starts to learn the HB presence or absence information, the subtraction counter starts to count. The default of the HB presence or absence bit is 0, and when the HB reply packet is received from VM_{b2}, the HB presence or absence bit is set to 1, and the default is loaded into the subtraction counter. The HB presence or absence bit is set to 1 every time the HB reply packet transmitted from VM_{b2} is received, and the subtraction counter value is also returned to the default. When starting to act for the HB, the HB presence or absence bit values within the DC site A are lumped by the multiplexed packet, and transmitted to the HB-proxy server A. However, the function of the subtraction counter is not changed, and functions as a timer for determining whether there is the HB reply packet from VM_{b2}, or not. When the HB reply packet is not transmitted from VM_{b2}, because the default is not loaded into the counter, the subtraction continues. When eventually the counter value becomes 0, the HB presence or absence bit is set to 0. Because the HB presence or absence bit value is to be maintained at 1 while the HB reply packets are transmitted from VM_{b2}, there is a need to set a cycle of the counter to be longer than the transmission cycle, that is, the transmission cycle of the HB request packet of VMₐ₂, of the HB reply packet. In this embodiment, a time obtained by adding 1000 counts to the transmission cycle of HB request packet is set as the count cycle.

FIG. 20B illustrates an appearance of a change in the subtraction counter value and the HB presence or absence bit in VM_{b2} of the remote DC table within the HB-proxy server A in the above-mentioned sequence. When the HB-proxy server starts to learn the HB presence or absence information, the subtraction counter starts to count. The default of the HB presence or absence bit is 0, and when the HB reply packet is received from VM_{b2}, the HB presence or absence bit is set to 1, and the default is loaded into the subtraction counter. The HB presence or absence bit is set to 1 every time the HB reply packet transmitted from VM_{b2} is received, and the subtraction counter value is also returned to the default. Therefore, the subtraction counter functions as a timer for determining whether there is the HB request packet, or not. When starting to act for the HB, the HB presence or absence bit values are lumped by the multiplexed packet and transmitted from the HB-proxy server B, and the value of the HB presence or absence bit value of the remote DC table is updated. When the subtraction counter value becomes 0, the subtraction counter value returns to the default. The HB presence or absence bit is confirmed, and if the bit value is 1, the HB reply packet is transmitted to VMₐ₂. Therefore, the subtraction counter during HB-proxy functions as a timer for measuring the transmission cycle of the HB reply packet. On the other hand, if the bit value is 0, the HB reply packet is not transmitted to VMₐ₂.

In the above description, “heartbeat” and “heartbeat signal” are mainly used. However, “heartbeat” can include not only the direct name, but also signals for monitoring life and death, and the other appropriate reference signals.

What is claimed is:

1. A communication system in which servers in a plurality of sites transmit and receive heartbeat (HB) packets with respect to each other in an HB transmission cycle through a network (NW), wherein
each of the sites includes:
a plurality of servers corresponding to a plurality of servers in another site;
a local-site table that stores a counter, a default of the counter, and HB presence or absence information, at a local-site side server address;
a remote site table that stores a counter, a default of the counter, and HB presence or absence information, at a remote site side server address corresponding to the local-site side server address; and
an HB-proxy server that receives an HB packet from each of the servers, and manages the local-site table and the remote site table,
after starting to act for the HB transmission and reception,
when an HB packet is transmitted from a first server of a first site, a default is loaded into the counter at an address of the first server in a first local-site table of a first HB-proxy server of the first site, and a presence of HB is set to the HB presence or absence information,
on the other hand, when the first server fails, the HB packet is not transmitted to the first HB-proxy server, the default is not loaded into the counter at the address of the first server of the first local-site table, the first HB-proxy server continues to count the counter, and the HB presence or absence information is set to no presence of HB when the counter expires,
the first HB-proxy server refers to the first local-site table at given time intervals, generates a multiplexed HB packet including in a lump the updated HB presence or absence information of the respective servers of the first site, and transmits the multiplexed HB packet to a second HB-proxy server of a second site,
the second HB-proxy server updates the respective HB presence or absence information of a second remote site table of the second HB-proxy server according to the received multiplexed HB packet,
the second HB-proxy server counts the counter, refers to the second remote site table, and, when a counter of a certain remote site side server address is expired, transmits the HB packet to a second server of the second site at the certain remote site side server address if the HB presence or absence information indicates presence of HB and
on the other hand, the second server determines that the corresponding first server fails on the basis of a fact that the HB packet is not transmitted to the second server if the HB presence or absence information indicates no presence of HB.

2. The communication system according to claim 1,
wherein before starting to act for the HB transmission and reception,
the first HB-proxy server
counts the counter,
transfers the HB packet to the NW side as it is when the HB packet is transmitted from the first server, and
the first HB-proxy server sets the HB presence or absence information to 1 at the server address of the first server of the first local-site table, and loads the default into the counter, and
the second HB-proxy server
upon receiving the HB packet through the NW, sets the HB presence or absence information to 1 at the server address of the first server of the second remote site table, and loads the default in the counter.

3. The communication system according to claim 1,
wherein each of the HB-proxy servers,
on the basis of information input from a maintenance terminal,
sets the local-site side server address of the local-site table to correspond to the remote site side server address of the remote site table,
sets the default of the counter of the local-site table to be longer than the HB transmission cycle of the server of the local-site, and
sets the default of the counter of the remote site table to be the HB transmission cycle of the server of the remote site.

4. A communication system in which servers in a plurality of sites transmit and receive heartbeat (HB) packets with respect to each other in an HB transmission cycle through a network (NW), wherein
each of the sites includes:
a plurality of servers corresponding to a plurality of servers in another site;
a local-site table that stores a counter, a default of the counter, and HB presence or absence information, at a local-site side server address;
a remote site table that stores a counter, a default of the counter, and HB presence or absence information, at a remote site side server address corresponding to the local-site side server address; and
an HB-proxy server that receives an HB request packet and an HB reply packet from each of the servers, and manages the local-site table and the remote site table, wherein
after starting to act for the HB transmission and reception,
a second HB-proxy server of a second site refers to a second local-site table of the second HB-proxy server at predetermined regular time intervals, generates a multiplexed HB packet including in a lump the HB presence or absence information of the respective servers of the second site, and transmits the multiplexed HB packet to the first HB-proxy server of the first site,
the second HB-proxy server counts the counter, loads the default when the counter at a certain remote site side server address, of a second remote site table of the second HB-proxy server expires, and transmits an HB request packet to a second server corresponding to the first server of the remote site side server address if the HB presence or absence information indicates presence of HB, and the second server transmits the HB reply packet when receiving the HB request packet if the second server is normal,
the second HB-proxy server sets the HB presence or absence information to presence of HB at the address of the second server every time the HB reply packet is received from the second server in the second local-site table, and loads the default into the counter,
on the other hand, when the second server fails, because the HB reply packet is not returned, the default is not loaded into the counter at the address of the second server of the second local-site table, and sets the HB presence or absence information to no presence of HB if the counter expires after a given time,
the first HB-proxy server updates the respective HB presence or absence information of the first remote site table of the first HB-proxy server according to the received multiplexed HB packet,
upon receiving the HB request packet from the first server, the first HB-proxy server refers to the updated first remote site table, and returns the HB reply packet to the first server if the HB presence or absence information at the address of the second server corresponding to the first server indicates presence of HB, and
on the other hand, if the HB presence or absence information at the address of the second server corresponding to the first server indicates no presence of HB, the first server determines that the corresponding second server fails, on the basis of a fact that the HB reply packet is not transmitted to the first server.

5. The communication system according to claim 4,
wherein before starting to act for the HB transmission and reception,
the first HB-proxy server and the second HB-proxy server count the counters of the local-site table and the remote site table,
upon receiving the HB request packet from the first server, the first HB-proxy server transfers the received HB packet to the NW side,
upon receiving the HB request packet through the NW, the second HB-proxy server sets the HB presence or absence information to presence of HB at the server address of the first server of the second remote site table of the second HB-proxy server, and loads the default into the counter,
the second HB-proxy server transmits the HB request packet to the second server corresponding to the first server,
if the second server is normal, the second server returns the HB reply packet upon receiving the HB request packet, and
upon receiving the HB reply packet, the second HB-proxy server sets the HB presence or absence information to presence of HB at the server address of the second server of the second local-site table, and loads the default into the counter.

6. The communication system according to claim 4,
wherein each of the HB-proxy servers,
on the basis of information input from a maintenance terminal,
sets the server addresses of the local-site table and the remote site table to correspond to each other,
sets the default of the counter of the local-site table to be longer than the HB transmission cycle of the server of the remote site, and
sets the default of the counter of the remote site table to be the HB transmission cycle of the server of the remote site.

7. A communication method in a communication system in which servers in a plurality of sites transmit and receive heartbeat (HB) packets with respect to each other in an HB transmission cycle through a network (NW), wherein
each of the sites includes:
a plurality of servers corresponding to a plurality of servers in another site;
a local-site table that stores a counter, a default of the counter, and HB presence or absence information, at a local-site side server address;
a remote site table that stores a counter, a default of the counter, and HB presence or absence information, at a remote site side server address corresponding to the local-site side server address; and
an HB-proxy server that receives an HB packet from each of the servers, and manages the local-site table and the remote site table,
after starting to act for the HB transmission and reception,
when an HB packet is transmitted from a first server of a first site, a default is loaded into the counter at an address of the first server in a first local-site table of a first HB-proxy server of the first site, and a @resemce pf HB is set to the HB presence or absence information,
on the other hand, when the first server fails, the HB packet is not transmitted to the first HB-proxy server, the default is not loaded into the counter at the address of the first server of the first local-site table, the first HB-proxy server continues to count the counter, and the HB presence or absence information is set to no presence of HB when the counter expires,
the first HB-proxy server refers to the first local-site table at given time intervals, generates a multiplexed HB packet including in a lump the updated HB presence or absence information of the respective servers of the first site, and transmits the multiplexed HB packet to a second HB-proxy server of a second site,
the second HB-proxy server updates the respective HB presence or absence information of a second remote site table of the second HB-proxy server according to the received multiplexed HB packet,
the second HB-proxy server counts the counter, refers to the second remote site table, and when a counter of a certain remote site side server address is expired, transmits the HB packet to a second server of the second site at the certain remote site side server address if the HB presence or absence information indicates presence of HB and
on the other hand, the second server determines that the corresponding first server fails on the basis of a fact that the HB packet is not transmitted to the second server if the HB presence or absence information indicates no presence of HB.

8. A communication method in a communication system in which servers in a plurality of sites transmit and receive heartbeat (HB) packets with respect to each other in an HB transmission cycle through a network (NW), wherein
each of the sites includes:
a plurality of servers corresponding to a plurality of servers in another site;
a local-site table that stores a counter, a default of the counter, and HB presence or absence information, at a local-site side server address;
a remote site table that stores a counter, a default of the counter, and HB presence or absence information, at a remote site side server address corresponding to the local-site side server address; and
an HB-proxy server that receives an HB request packet and an HB reply packet from each of the servers, and manages the local-site table and the remote site table, wherein
after starting to act for the HB transmission and reception,
a second HB-proxy server of a second site refers to a second local-site table of the second HB-proxy server at predetermined regular time intervals, generates a multiplexed HB packet including in a lump the HB presence or absence information of the respective servers of the second site, and transmits the multiplexed HB packet to the first HB-proxy server of the first site,
the second HB-proxy server counts the counter, loads the default when the counter at a certain remote site side server address, of a second remote site table of the second HB-proxy server expires, and transmits an HB request packet to a second server corresponding to the first server of the remote site side server address if the HB presence or absence information indicates presence of HB, and the second server transmits the HB reply packet when receiving the HB request packet if the second server is normal,
the second HB-proxy server sets the HB presence or absence information to presence of HB at the address of the second server every time the HB reply packet is received from the second server in the second local-site table, and loads the default into the counter,
on the other hand, when the second server fails, because the HB reply packet is not returned, the default is not loaded into the counter at the address of the second server of the second local-site table, and sets the HB presence or absence information to no presence of HB if the counter expires after a given time,
the first HB-proxy server updates the respective HB presence or absence information of the first remote site table of the first HB-proxy server according to the received multiplexed HB packet,
upon receiving the HB request packet from the first server, the first HB-proxy server refers to the updated first remote site table, and returns the HB reply packet to the first server if the HB presence or absence information at the address of the second server corresponding to the first server indicates presence of HB, and
on the other hand, if the HB presence or absence information at the address of the second server corresponding to the first server indicates no presence of HB, the first server determines that the corresponding second server fails, on the basis of a fact that the HB reply packet is not transmitted to the first server.

9. A heartbeat actiong server in a communication system in which servers in a plurality of sites transmit and receive heartbeat (HB) packets with respect to each other in an HB transmission cycle through a network (NW), and each of the sites includes a plurality of servers corresponding to a plurality of servers in another site,
each of the HB-proxy servers of each of the sites comprising:
a local-site table that stores a counter, a default of the counter, and HB presence or absence information, at a local-site side server address;
a remote site table that stores a counter, a default of the counter, and HB presence or absence information, at a remote site side server address corresponding to the local-site side server address;
wherein each of the HB-proxy servers receives an HB packet from each of the servers, and manages the local-site table and the remote site table,
after starting to act for the HB transmission and reception,
when an HB packet is transmitted from a first server of a first site, a default is loaded into the counter at an address of the first server in a first local-site table of a first HB-proxy server of the first site, and a @resemce pf HB is set to the HB presence or absence information,
on the other hand, when the first server fails, the HB packet is not transmitted to the first HB-proxy server, the default is not loaded into the counter at the address of the first server of the first local-site table, the first HB-proxy server continues to count the counter, and the HB presence or absence information is set to no presence of HB when the counter expires,
the first HB-proxy server refers to the first local-site table at given time intervals, generates a multiplexed HB packet including in a lump the updated HB presence or absence information of the respective servers of the first site, and transmits the multiplexed HB packet to a second HB-proxy server of a second site,
the second HB-proxy server updates the respective HB presence or absence information of a second remote site table of the second HB-proxy server according to the received multiplexed HB packet,
the second HB-proxy server counts the counter, refers to the second remote site table, and when a counter of a certain remote site side server address is expired, transmits the HB packet to a second server of the second site at the certain remote site side server address if the HB presence or absence information indicates presence of HB and
on the other hand, the second server determines that the corresponding first server fails on the basis of a fact that the HB packet is not transmitted to the second server if the HB presence or absence information indicates no presence of HB.

10. A heartbeat actiong server in a communication system in which servers in a plurality of sites transmit and receive heartbeat (HB) packets with respect to each other in an HB transmission cycle through a network (NW), and each of the sites includes a plurality of servers corresponding to a plurality of servers in another site,
each of the HB-proxy servers of each of the sites comprising:
a local-site table that stores a counter, a default of the counter, and HB presence or absence information, at a local-site side server address;
a remote site table that stores a counter, a default of the counter, and HB presence or absence information, at a remote site side server address corresponding to the local-site side server address;
wherein each of the HB-proxy servers receives an HB request packet and an HB reply packet from each of the servers, and manages the local-site table and the remote site table, wherein
after starting to act for the HB transmission and reception,
a second HB-proxy server of a second site refers to a second local-site table of the second HB-proxy server at predetermined regular time intervals, generates a multiplexed HB packet including in a lump the HB presence or absence information of the respective servers of the second site, and transmits the multiplexed HB packet to the first HB-proxy server of the first site,
the second HB-proxy server counts the counter, loads the default when the counter at a certain remote site side server address, of a second remote site table of the second HB-proxy server expires, and transmits an HB request packet to a second server corresponding to the first server of the remote site side server address if the HB presence or absence information indicates presence of HB, and the second server transmits the HB reply packet when receiving the HB request packet if the second server is normal,
the second HB-proxy server sets the HB presence or absence information to presence of HB at the address of the second server every time the HB reply packet is received from the second server in the second local-site table, and loads the default into the counter,
on the other hand, when the second server fails, because the HB reply packet is not returned, the default is not loaded into the counter at the address of the second server of the second local-site table, and sets the HB presence or absence information to no presence of HB if the counter expires after a given time,
the first HB-proxy server updates the respective HB presence or absence information of the first remote site table of the first HB-proxy server according to the received multiplexed HB packet,
upon receiving the HB request packet from the first server, the first HB-proxy server refers to the updated first remote site table, and returns the HB reply packet to the first server if the HB presence or absence information at the address of the second server corresponding to the first server indicates presence of HB, and
on the other hand, if the HB presence or absence information at the address of the second server corresponding to the first server indicates no presence of HB, the first server determines that the corresponding second server fails, on the basis of a fact that the HB reply packet is not transmitted to the first server.

11. The HB-proxy server according to claim 9,
comprising:
a site side HB transmitting unit and a site side HB receiving unit, which transmits and receives the HB information with respect to the server of the local-site, respectively;
an NW side HB transmitting unit and an NW side HB receiving unit, which transmits and receives the HB information with respect to the counter HB-proxy server, respectively;
a local-site table management unit that manages information of the local-site table that stores the HB information of the server of the local-site; and
a remote site table management unit that manages the remote site table that stores the HB information of the server of the remote site,
wherein the HB-proxy server has a function of transmitting in a lump the HB information of the server of the local-site to the HB-proxy server of the remote site.

12. The communication method according to claim 7,
wherein before starting to act for the HB transmission and reception,
the first HB-proxy server
counts the counter,
transfers the HB packet to the NW side as it is when the HB packet is transmitted from the first server, and
the first HB-proxy server sets the HB presence or absence information to 1 at the server address of the first server of the first local-site table, and loads the default into the counter, and
the second HB-proxy server
upon receiving the HB packet through the NW, sets the HB presence or absence information to 1 at the server address of the first server of the second remote site table, and loads the default in the counter.

13. The communication method according to claim 7,
wherein each of the HB-proxy servers,
on the basis of information input from a maintenance terminal,
sets the local-site side server address of the local-site table to correspond to the remote site side server address of the remote site table,
sets the default of the counter of the local-site table to be longer than the HB transmission cycle of the server of the local-site, and
sets the default of the counter of the remote site table to be the HB transmission cycle of the server of the remote site.

14. The communication method according to claim 8,
wherein before starting to act for the HB transmission and reception,
the first HB-proxy server and the second HB-proxy server count the counters of the local-site table and the remote site table,
upon receiving the HB request packet from the first server, the first HB-proxy server transfers the received HB packet to the NW side,
upon receiving the HB request packet through the NW, the second HB-proxy server sets the HB presence or absence information to presence of HB at the server address of the first server of the second remote site table of the second HB-proxy server, and loads the default into the counter,
the second HB-proxy server transmits the HB request packet to the second server corresponding to the first server,
if the second server is normal, the second server returns the HB reply packet upon receiving the HB request packet, and
upon receiving the HB reply packet, the second HB-proxy server sets the HB presence or absence information to presence of HB at the server address of the second server of the second local-site table, and loads the default into the counter.

15. The communication method according to claim 8,
wherein each of the HB-proxy servers,
on the basis of information input from a maintenance terminal,
sets the server addresses of the local-site table and the remote site table to correspond to each other,
sets the default of the counter of the local-site table to be longer than the HB transmission cycle of the server of the remote site, and
sets the default of the counter of the remote site table to be the HB transmission cycle of the server of the remote site.
